(19) United States
(12) Patent Application Publication
(10) Pub. No.: US 2020/0362236 A1
(43) Pub. Date: Nov. 19, 2020

(54) OPTICAL DEVICES FOR EFFICIENT EMISSION AND/OR ABSORPTION OF ELECTROMAGNETIC RADIATION, AND ASSOCIATED SYSTEMS AND METHODS

(71) Applicant: Massachusetts Institute of Technology, Cambridge, MA (US)

(72) Inventors: Kehang Cui, Allston, MA (US); Anastasios John Hart, Waban, MA (US)

(73) Assignee: Massachusetts Institute of Technology, Cambridge, MA (US)

(21) Appl. No.: 16/464,401

(22) PCT Filed: Nov. 28, 2017
(86) PCT No.: PCT/US2017/063376

§ 371 Date: May 28, 2019

Related U.S. Application Data
(60) Provisional application No. 62/426,793, filed on Nov. 28, 2016.

(51) Int. Cl. C09K 11/68; C01B 32/162; C01B 32/168; H02S 10/30

(52) U.S. Cl. CPC C09K 11/68; C01B 32/162; B82Y 40/00; H02S 10/30; C01B 2202/08; C01B 32/168

(57) ABSTRACT

Optical materials and associated systems and methods are generally provided.

### RELATED APPLICATIONS

This application is a national stage filing under 35 U.S.C. § 371 of International Patent Application Serial No. PCT/US2017/063376, filed Nov. 28, 2017, entitled “Optical Devices for Efficient Emission and/or Absorption of Electromagnetic Radiation, and Associated Systems and Methods,” which claims priority under 35 U.S.C. § 119(e) to U.S. Provisional Application No. 62/426,793, filed Nov. 28, 2016, and entitled “Nanopatterned Carbon Nanotube Surfaces for Stable Selective Emitters in Thermophotovoltaics,” each of which is incorporated herein by reference in its entirety for all purposes.

### GOVERNMENT SUPPORT

This invention was made with Government support under Grant No. CMMI1463181 awarded by the National Science Foundation (NSF). The Government has certain rights in the invention.

### TECHNICAL FIELD

Optical materials for emission and/or absorption of electromagnetic radiation are generally described.

### BACKGROUND

While some metallic and photonic crystals have demonstrated good specular and angular selectivity, refractory metal-based photonic crystals have generally only been fabricated through deep reactive ion etching (DRIE) processes. The manufacturing complexity and scalability of metallic photonic crystals limit their widespread application. Some photovoltaic cells could achieve higher power conversion efficiency if they had larger bandgaps, which might require a very high operating temperature (e.g., in excess of 1300° C.). Refractory metals suffer from surface diffusion, causing photonic crystals (PhCs) fabricated from them to exhibit undesirable and significant structural changes. Structure and property degradation of metallic PhCs at high temperatures is another limiting factor for widespread applications of TPVs.

### SUMMARY

Optical materials for emission and/or absorption of electromagnetic radiation as well as related components and methods associated therewith are provided. The optical materials can be used, according to certain embodiments, in thermophotovoltaic systems. The subject matter of the present invention involves, in some cases, interrelated products, alternative solutions to a particular problem, and/or a plurality of different uses of one or more systems and/or articles.

Certain embodiments relate to materials comprising a network of carbon nanotubes. The material may be structured with a periodic pattern having a characteristic dimension smaller than 1 um. The CNTs may be coated with a second material.

In some embodiments, a material may comprise a network of carbon nanotubes. At least one surface of the material may be structured with a periodic pattern having a characteristic dimension smaller than 1 um, and/or at least one surface may not be structured with a periodic pattern.

Certain embodiments relate to thermophotovoltaic devices. A thermophotovoltaic device may comprise a surface including CNTs patterned with a periodic arrangement with a characteristic dimension of 1 um or smaller.

Certain embodiments relate to optical materials. An optical material may comprise a matrix comprising a collection of elongated nanostructures and a coating material at least partially coating the collection of elongated nanostructures. The optical material may comprise an array comprising a plurality of cavities disposed within the matrix.

Certain embodiments relate to methods. A method may comprise depositing a coating material on a collection of elongated nanostructures arranged such that an array comprising a plurality of cavities is disposed within the collection of elongated nanostructures.

Certain embodiments relate to emitters. An emitter may comprise an emission surface and an optical material disposed over at least a portion of the emission surface. In some embodiments, after the emitter has been heated to a temperature of at least 1200 Kelvin for a period of at least 150 hours, the emitter is capable of exhibiting an emission efficiency of at least 40%.

Certain embodiments relate to absorbers. An absorber may comprise an absorption surface and an optical material disposed over at least a portion of the absorption surface. In some embodiments, after the absorber has been heated to a temperature of at least 1200 Kelvin for a period of at least 150 hours, the absorber is capable of exhibiting an absorption efficiency of at least 85%.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction of an optical material, according to certain embodiments;

FIG. 2 is a schematic depiction of a matrix, according to certain embodiments;

FIG. 3 is a schematic depiction of a method of making an optical material, according to certain embodiments;

FIG. 4A is a schematic depiction of an emitter, according to certain embodiments;

FIG. 4B is a schematic depiction of an absorber, according to certain embodiments;

FIG. 4C is a schematic depiction of a composite material, according to certain embodiments;

FIG. 5A is a schematic diagram of a thermophotovoltaic energy generation system, according to certain embodiments;

FIG. 5B is a schematic illustration of an energy generation system, according to certain embodiments;

FIGS. 6A and 6B are schematic depictions of methods of making optical materials, according to certain embodiments;

FIG. 7 is a schematic depiction of a method of performing interference lithography, according to certain embodiments;

FIG. 8 is a schematic depiction of the interaction between photons and photovoltaic materials, according to certain embodiments;

FIG. 9 shows the functionality of a selective absorber and a selective emitter, the ideal absorption of a perfect absorber, and the calculated emittance from a blackbody radiator held at 1500 K, according to certain embodiments;

FIG. 10 is a schematic depiction of an approach to forming patterned carbon nanotubes on a patterned catalyst, according to certain embodiments;

FIG. 11 shows the results of a finite-difference time domain simulation and a structure fabricated based on the results of a finite-difference time domain simulation, according to certain embodiments;

FIG. 12 shows a method of forming a patterned catalyst on a substrate and micrographs showing a material formed on the patterned catalyst, according to certain embodiments;

FIG. 13 shows a schematic depiction of a system for growing carbon nanotubes, a schematic depiction of a method of growing carbon nanotubes, and micrographs showing carbon nanotubes grown employing the system and method, according to certain embodiments;

FIG. 14 shows micrographs of carbon nanotubes, according to certain embodiments;

FIG. 15 shows a schematic depiction of a method of depositing tungsten on carbon nanotubes, and micrographs of tungsten-coated carbon nanotubes, according to certain embodiments;

FIG. 16 shows micrographs of tungsten- and alumina-coated carbon nanotubes, according to certain embodiments;

FIG. 17 shows the absorptivity and emissivity of certain optical materials, according to certain embodiments;

FIG. 18A is a schematic depiction of an ideal absorber, an ideal emitter, and a matrix, according to certain embodiments;

FIG. 18B shows emittance as a function of wavelengths and micrographs of certain matrices, according to certain embodiments;

FIG. 18C shows the efficiency of an absorber as a function of cutoff wavelength and temperature, according to certain embodiments;

FIG. 18D shows the efficiency of an emitter as a function of cutoff wavelength and temperature, according to certain embodiments;

FIG. 18E shows the efficiency of an absorber as a function of cavity diameter and cavity periodicity, according to certain embodiments;

FIG. 18F shows the efficiency of an emitter as a function of cavity diameter and cavity periodicity, according to certain embodiments;

FIGS. 19A-19D show micrographs of optical materials, according to certain embodiments;

FIG. 20A shows the absorbance of optical materials, according to certain embodiments;

FIG. 20B shows the emittance of optical materials, according to certain embodiments;

FIG. 20C shows the absorbance as a function of angle for optical materials, according to certain embodiments;

FIG. 20D shows the emittance as a function of angle for optical materials, according to certain embodiments;

FIGS. 21A-21D show micrographs of optical materials, according to certain embodiments;

FIGS. 21E and 21F show the diameter distribution of cavities within optical materials, according to certain embodiments;

FIG. 21G shows X-ray diffraction spectra of optical materials, according to certain embodiments;

FIG. 22A shows the efficiency of an absorber as a function of input power and temperature, according to certain embodiments;

FIG. 22B shows the efficiency of an emitter as a function of temperature and bandgap, according to certain embodiments;

FIG. 22C shows the efficiency of a system as a function of input power and temperature, according to certain embodiments;

FIGS. 23A and 23B show micrographs of optical materials, according to certain embodiments;

FIG. 23C shows the reflectance as a function of wavelength for optical materials, according to certain embodiments;

FIGS. 23D and 23E are atomic force microscopy images of surfaces of optical materials, according to certain embodiments;

FIGS. 24A and 24B show the absorbance and emittance of optical materials, according to certain embodiments;

FIGS. 25A and 25B show micrographs of absorbers and emitters, according to certain embodiments; and

FIG. 26 shows the angular dependence of absorbers and emitters as a function of wavelength and incident angle, according to certain embodiments.

### DETAILED DESCRIPTION

Articles and methods relating to optical materials, and devices incorporating optical materials, are generally provided. In some embodiments, an optical material may comprise a matrix and an array of cavities disposed within the matrix. The matrix may have one or more advantageous features. As an example, the matrix may comprise one or more components that render the optical material advantageous for use in certain applications. For instance, the matrix as a whole may be stable for extended periods of time at high temperatures, rendering the matrix capable of undergoing a high temperature annealing process and/or operating at a high temperature without appreciable degradation. In some embodiments, the matrix may comprise one or more materials that are stable for extended periods of time at high temperatures, and/or may comprise one or more materials (or be completely formed from materials) that are not stable at high temperatures in isolation but are stable at high temperatures when combined with the other materials in the matrix. Examples of suitable materials may include elongated nanostructures and/or one or more materials coating a collection of elongated nanostructures. As another example, the matrix may have a thickness (e.g., above a certain minimum value), and/or a root mean square surface roughness, that enhance one or more optical properties of the optical material (e.g., its absorbance of certain wavelengths of light, its emittance of certain wavelengths of light).

In certain embodiments, methods directed to forming optical materials with one or more advantageous properties are provided. The methods may result in relatively rapid production of optical materials, relatively inexpensive production of optical materials, and/or production of optical materials that could not be formed, or could only be formed at appreciable difficulty and/or expense, using other techniques. For instance, a method may comprise one or more steps that allow parallel creation of many features simultaneously and/or that result in bottom-up growth of one or more features to form desired structure(s). In some embodiments, a method may comprise the formation of an initial pattern using a facile and/or inexpensive technique, and formation of further structures (e.g., one or more matrix components, a matrix) on the initial pattern. For instance, a collection of elongated nanostructures may be grown in a pattern, and a coating material may be deposited on the patterned nanostructures to form a matrix comprising the elongated nanostructures and the coating material. A matrix formed by this process may further comprise an array of cavities (e.g., in locations where the elongated nanostructures did not form).

In some embodiments, optical materials as described herein may have particular utility as components of emitters and/or absorbers, such as emitters and/or absorbers configured to act as components of photovoltaic and/or thermophotovoltaic cells. An absorber comprising an optical material as described herein may, in certain cases, exhibit high levels of absorbance of many wavelengths of light. In some cases, an emitter comprising an optical material as described herein may exhibit high levels of emittance of certain wavelengths of light (e.g., wavelengths of light corresponding to photons with an energy equal to the bandgap energy of a photovoltaic material to which the emitter is coupled, wavelengths of light corresponding to photons with an energy above the bandgap energy of a photovoltaic material to which the emitter is coupled, etc.). In other words, optical materials described herein may be components of absorbers that are capable of exhibiting high absorption efficiencies, and/or may be components of emitters that are capable of exhibiting high emission efficiencies.

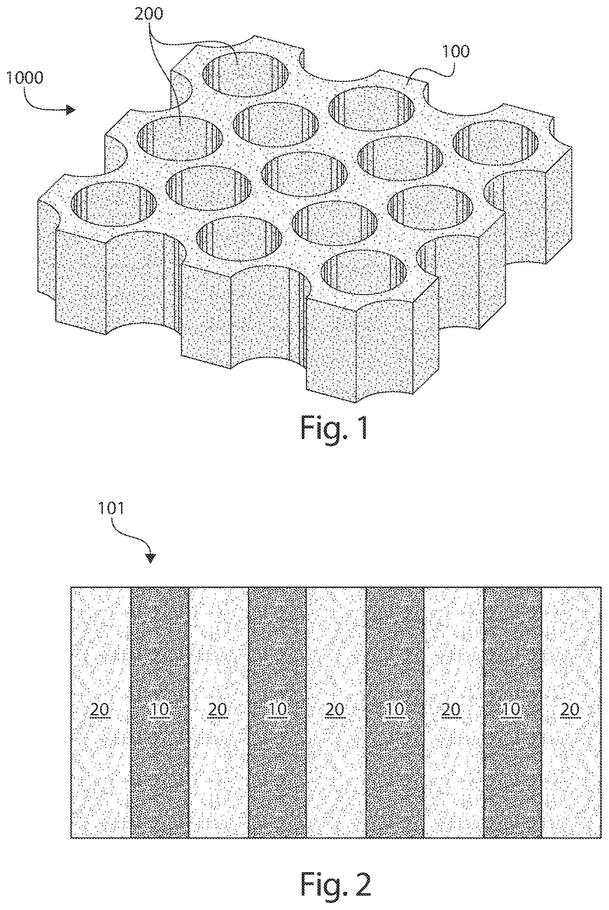

As described above, certain embodiments are related to optical materials. An optical material may comprise a matrix and an array comprising a plurality of cavities disposed within the matrix. FIG. 1 shows one non-limiting example of an optical material 1000 comprising a matrix 100 and an array comprising a plurality of cavities 200. In certain embodiments, like as shown in FIG. 1, the plurality of cavities are positioned in a pattern, the cavities are cylindrical, and/or the cavities are positioned in a square array. However, it should be understood that FIG. 1 is merely exemplary and that the arrangement of the cavities, the shape of the cavities, the size of the cavities, the relative amount of the optical material occupied by the cavities, the thickness of the matrix, and other features of the optical material can be different than those in the optical material shown in FIG. 1.

In some embodiments, as described above, the matrix may comprise one or more materials. For instance, the matrix may comprise a collection of elongated nanostructures and a coating material at least partially coating the collection of elongated nanostructures. FIG. 2 shows one non-limiting embodiment of a matrix 101 comprising a collection of elongated nanostructures 10 and a coating material 20 disposed on the collection of elongated nanostructures. In certain embodiments, like as shown in FIG. 2, the collection of elongated nanostructures and the coating material may together form a matrix with very few or no voids (e.g., other than the cavities therein). In other embodiments, the collection of elongated the coating material may not fully fill the spaces between the elongated nanostructures, and the matrix may comprise appreciable numbers of voids and/or voids that occupy an appreciable fraction of the volume of the matrix (e.g., in addition to the cavities therein). In some embodiments, like as shown in FIG. 2, a matrix may comprise one coating material. In other embodiments, a matrix may comprise two or more coating materials. Similarly, it should be understood that the relative volume fractions of the collection of elongated nanostructures and the coating material, and other features of the matrix shown in FIG. 2, are purely exemplary and that matrices differing from the matrix shown in FIG. 2 in one or more ways are also contemplated.

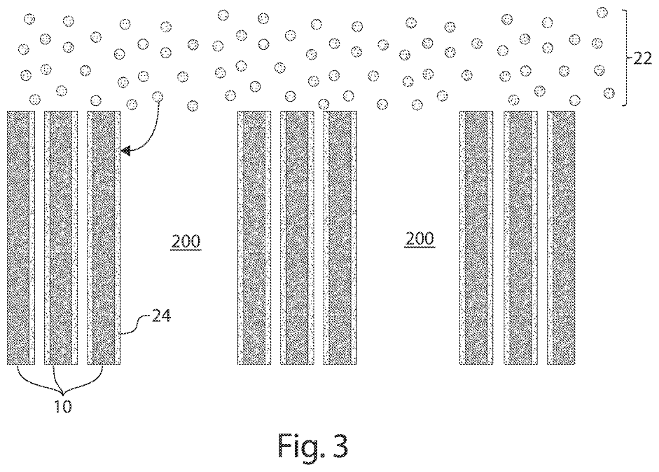

In some embodiments, methods of making optical materials are contemplated. FIG. 3 shows one non-limiting embodiment of a method of making an optical material. In FIG. 3, a coating material 22 is deposited on a collection of elongated nanostructures 10. Deposition of the coating material onto the collection of elongated nanostructures results in the formation of a coating 24 that at least partially coats the collection of elongated nanostructures. The collection of elongated nanostructures is arranged such that an array comprising a plurality of cavities 200 is disposed within the collection of elongated nanostructures. Like for FIGS. 1 and 2, it should be understood that FIG. 3 is merely exemplary and that certain methods may comprise features similar to those shown in FIG. 3 and certain methods may comprise features different from those shown in FIG. 3. In some embodiments, a method of making an optical material may comprise one or more steps in addition to those shown in FIG. 3 (and/or may not comprise the step shown in FIG. 3). Further description of methods contemplated herein is provided below.

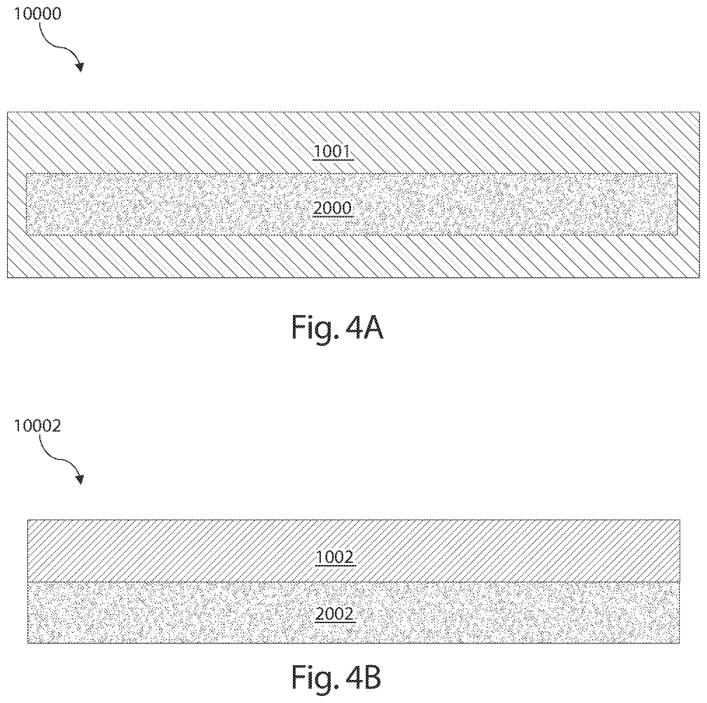

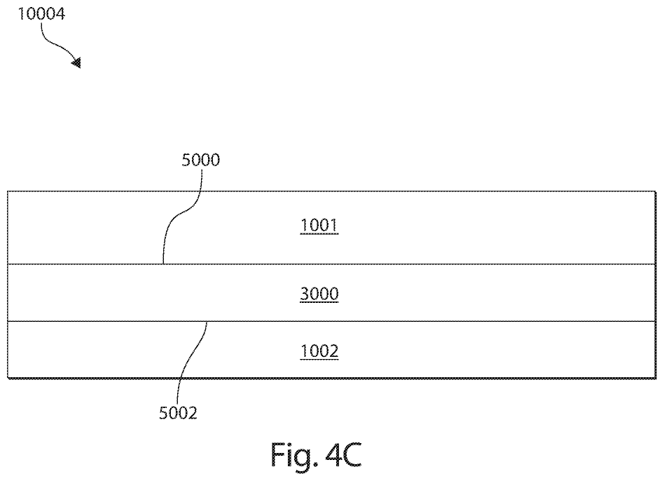

In certain cases, optical materials described herein may be configured for use in a thermophotovoltaic cell. In certain cases, optical materials described herein may form part of a thermophotovoltaic cell. As an example, in some embodiments, an optical material may be configured to act as a component of an emitter in a thermophotovoltaic cell, and/or may form part of an emitter of a thermophotovoltaic cell. For instance, the optical material may be disposed over at least a portion of an emission surface. FIG. 4A shows one non-limiting embodiment of an emitter 10000 comprising an optical material 1001 disposed on an emission surface 2000. As another example, in some embodiments, an optical material may be configured to act as a component of an absorber in a thermophotovoltaic cell, and/or may form part of an absorber of a thermophotovoltaic cell. For instance, the optical material may be disposed over at least a portion of an absorption surface. FIG. 4B shows one non-limiting embodiment of an absorber 10002 comprising an optical material 1002 disposed on an absorption surface 2002. It should be understood that when an optical material is configured to act as a component of an absorber and/or emitter, the absorber and/or emitter may be incorporated into a thermophotovoltaic cell further comprising additional components, such as photovoltaic materials, external electronics, and the like (not shown).

In some embodiments, two or more optical materials (e.g., two or more optical materials as described herein) may be formed on a single substrate to form a single composite material. For instance, an absorber may be formed on one side of a substrate, and an emitter may be formed on the opposite side of the same substrate; together, the substrate, emitter, and absorber may form a single composite material. As will be described in further detail below, it may be possible to fabricate composite materials comprising both an emitter and an absorber in fewer steps than would be employed to fabricate separate emitters and absorbers. FIG. 4C shows one non-limiting embodiment of a composite material 10004 comprising optical material 1001 disposed on first surface 5000 of substrate 3000 (forming an emitter); optical material 1002 disposed on second surface 5002 of substrate 3000 (forming an absorber); and substrate 3000 positioned between optical materials 1001 and 1002. In this embodiment, composite material 10004 can function as both an absorber and an emitter. According to certain embodiments, optical materials 1001 and/or 1002 can be formed of a forest of elongated nanostructures (e.g., carbon nanotubes) that is at least partially coated by one or more materials (e.g., tungsten, alumina, and/or any of the other such coating materials mentioned elsewhere herein).

In some embodiments, a composite material may function as a thermal diode. In other words, it may comprise an absorber that absorbs a broad range of wavelengths, and an emitter that emits a selected range of wavelengths (e.g., a range of wavelengths above the bandgap of a photovoltaic material onto which the composite material is configured to dispose radiation). The absorber and emitter may be in thermal communication with each other, such that a portion of the energy absorbed by the absorber is emitted as light by the emitter. In some embodiments, the portion of energy absorbed by the absorber that is emitted as light by the emitter may be relatively large (e.g., greater than or equal to 80% of the energy absorbed by the absorber may be emitted as light by the emitter). In certain cases, a composite material may be configured to emit selectively in a range of directions (e.g., a range of directions towards a photovoltaic material).

As described above, an optical material as described herein may comprise a matrix and an array comprising a plurality of cavities disposed within the matrix. The plurality of cavities may be arranged within the matrix in any suitable manner. In some embodiments, computations, such as ab-initio finite-difference time domain (FDTD) calculations, may be employed to determine the placement, size, and/or shape of the cavities. In some embodiments, the plurality of cavities may be positioned in a pattern. The pattern may be a periodic pattern, i.e., a pattern that comprises a motif, such as a cavity, that repeats spatially at a defined period. Patterns that are periodic patterns may be perfectly periodic (i.e., the motif or cavity may occur in positions that are separated from each other by vectors of constant distance and orientation), or the periodic pattern may deviate from perfect periodicity in one or more ways (e.g., the motif or cavity may be present at one or more positions in addition to those at which it would be present if the pattern was perfectly periodic, the motif or cavity may be absent at one or more positions at which it would be present if the pattern was perfectly periodic, the motif or cavity may be present at one or more positions slightly offset from the positions at which it would be present if the pattern was perfectly periodic, and the like). References herein to patterns that are periodic should be understood to refer to patterns that are perfectly periodic and patterns that deviate from perfect periodicity in one or more ways, unless otherwise specified.

As described above, in some embodiments, a pattern may be periodic, and one or more motifs and/or cavities may be present at one or more positions slightly offset from the position(s) at which the one or more motifs and/or one or more cavities would be present if the pattern was periodic. The average deviation of a motif or cavity from the position at which it would be present if the pattern was perfectly periodic may be less than or equal to 10%, less than or equal to 5%, less than or equal to 2%, or less than or equal to 1% of the average distance between the motifs or cavities. The average deviation of a motif or cavity from the position at which it would be present if the pattern was perfectly periodic may be greater than or equal to 0%, greater than or equal to 1%, greater than or equal to 2%, or greater than or equal to 5% of the average distance between the motifs or cavities. Combinations of the above-referenced ranges are also possible (e.g., less than or equal to 10% and greater than or equal to 0%). Other ranges are also possible. The average deviation of a motif or cavity from the position at which it would be present if the pattern was perfectly periodic may be determined by microscopy.

In some embodiments, a plurality of cavities may be positioned in a pattern that is periodic in one dimension. In such patterns, there may be one direction within the optical material along which cavities are spaced from each other at a defined period. In other directions perpendicular to the direction along which cavities are spaced from each other at a defined period, for patterns that are periodic in one direction, the cavities are not spaced from each other at a defined period (e.g., they are randomly spaced from each other, they occupy the entirety of the optical material along that direction, they are absent).

In some embodiments, a plurality of cavities may be positioned in a pattern that is periodic in two dimensions. In such patterns, there may be two non-collinear direction within the optical material along which cavities are spaced from each other at defined periods. In the direction perpendicular to the directions along which cavities are spaced from each other at a defined period, for patterns that are periodic in two dimensions, the cavities are not spaced from each other at a defined period (e.g., they are randomly spaced from each other, they occupy the entirety of the optical material along that direction, they are absent).

In some embodiments, a plurality of cavities may be positioned in a pattern that is periodic in three dimensions. In such patterns, there may be three non-coplanar direction within the optical material along which cavities are spaced from each other at defined periods.

In some embodiments, an optical material may be a photonic crystal. As used herein, the term “photonic crystal” is given its ordinary meaning in the art, and refers to a material that can control the propagation of electromagnetic radiation based on a periodic assembly of domains having different dielectric properties. In some embodiments, the photonic crystals include domains with one or more dimensions of the same order of magnitude as the wavelength(s) of the electromagnetic radiation the photonic crystal is configured to control the propagation of.

In embodiments in which an optical material comprises a plurality of cavities that is positioned in a periodic pattern, periodic pattern may have a characteristic dimension of any suitable value (e.g., a characteristic dimension of less than or equal to 1 micron). The characteristic dimension may be a period, a largest cross-sectional diameter, or any other dimension within the periodic pattern.

In embodiments in which an optical material comprises a plurality of cavities that is positioned in a periodic pattern, the period may be any suitable value. The period may be greater than or equal to 100 nm, greater than or equal to 200 nm, greater than or equal to 500 nm, greater than or equal to 1 micron, greater than or equal to 2 microns, greater than or equal to 5 microns, or greater than or equal to 10 microns. The period may be less than or equal to 20 microns, less than or equal to 10 microns, less than or equal to 5 microns, less than or equal to 2 microns, less than or equal to 1 micron, less than or equal to 500 nm, or less than or equal to 200 nm. Combinations of the above-referenced ranges are also possible (e.g., greater than or equal to 100 nm and less than or equal to 20 microns, or greater than or equal to 200 nm and less than or equal to 20 microns). Other ranges are also possible. The period may be determined by microscopy.

In some embodiments, a plurality of cavities may be positioned in a pattern that is not periodic. In certain of such embodiments, the pattern may have another type of symmetry. For instance, the pattern may have quasicrystalline symmetry.

In embodiments in which an optical material comprises a matrix and an array comprising a plurality of cavities disposed within the matrix, the cavities may occupy any suitable vol % of the matrix. The cavities may make up greater than or equal to 20 vol %, greater than or equal to 30 vol %, greater than or equal to 40 vol %, greater than or equal to 50 vol %, greater than or equal to 60 vol %, or greater than or equal to 70 vol % of the matrix. The cavities may make up less than or equal to 75 vol %, less than or equal to 70 vol %, less than or equal to 60 vol %, less than or equal to 50 vol %, less than or equal to 40 vol %, or less than or equal to 30 vol % of the matrix. Combinations of the above-referenced ranges are also possible (e.g., greater than or equal to 20 vol % and less than or equal to 75 vol %). Other ranges are also possible. The vol % of the matrix made up by cavities may be determined by microscopy.

In embodiments in which an optical material comprises a matrix and an array comprising a plurality of cavities disposed within the matrix, the cavities may occupy any percentage of the projected area of the matrix. The cavities may make up greater than or equal to 20%, greater than or equal to 30%, greater than or equal to 40%, greater than or equal to 50%, greater than or equal to 60%, or greater than or equal to 70% of the projected area of the matrix. The cavities may make up less than or equal to 75%, less than or equal to 70%, less than or equal to 60%, less than or equal to 50%, less than or equal to 40%, or less than or equal to 30% of the projected area of the matrix. Combinations of the above-referenced ranges are also possible (e.g., greater than or equal to 20% and less than or equal to 75% of the projected area of the matrix). Other ranges are also possible. As used herein, the % of the projected area of the matrix made up by cavities is the percent of the area of the matrix occupied by cavities when the matrix is projected in a direction perpendicular to its thickness. The % of the projected area of the matrix made up by cavities may be determined by microscopy.

In embodiments in which an optical material comprises a matrix and an array comprising a plurality of cavities disposed within the matrix, the average largest cross-sectional diameter of the cavities may be any suitable value. The average largest cross-sectional diameter of the cavities may be greater than or equal to 200 nm, greater than or equal to 500 nm, or greater than or equal to 1 micron. The average largest cross-sectional diameter of the cavities may be less than or equal to 2 microns, less than or equal to 1 micron, or less than or equal to 500 nm. Combinations of the above-referenced ranges are also possible (e.g., greater than or equal to 200 nm and less than or equal to 2 microns). Other ranges are also possible. As used herein, the average largest cross-sectional diameter of the cavities is the average, over all of the cavities in the plurality of cavities, of the largest cross-sectional diameter of each cavity. For cavities positioned in a periodic pattern, the largest cross-sectional diameter of each cavity is the longest line segment that may be drawn within the cavity that intersects the cavity only at its endpoints and is parallel to a direction of periodicity. For cavities not positioned in a periodic pattern, the largest cross-sectional diameter of each cavity is the longest line segment that may be drawn within the cavity that intersects the cavity only at its endpoints. The average largest cross-sectional diameter of the cavities may be determined by microscopy. When a composite material comprises both an emitter and an absorber, the average largest cross-sectional diameter of the cavities in the absorber may be smaller than the average largest cross-sectional diameter of the cavities in the emitter.

In embodiments in which an optical material comprises a matrix and an array comprising a plurality of cavities disposed within the matrix, the standard deviation of the largest cross-sectional diameter of the cavities may be any suitable value. The standard deviation of the largest cross-sectional diameter of the cavities may be greater than or equal to 0 nm, greater than or equal to 1 nm, greater than or equal to 2 nm, greater than or equal to 5 nm, greater than or equal to 10 nm, or greater than or equal to 20 nm. The standard deviation of the largest cross-sectional diameter of the cavities may be less than or equal to 30 nm, less than or equal to 20 nm, less than or equal to 10 nm, less than or equal to 5 nm, less than or equal to 2 nm, or less than or equal to 1 nm. Combinations of the above-referenced ranges are also possible (e.g., greater than or equal to 0 nm and less than or equal to 30 nm). Other ranges are also possible. As used herein, the standard deviation of the largest cross-sectional diameter of the cavities is the standard deviation of the largest cross-sectional diameter of the cavities, where the largest cross-sectional diameter of the cavities is the largest cross-sectional diameter of the cavities described above. The standard deviation of the largest cross-sectional diameter of the cavities may be determined by performing statistical analysis of micrographs of the optical material.

According to certain embodiments, the standard deviation of the largest cross-sectional diameter of the cavities in the matrix can be less than 10% (or less than 5%, or less than 2%, or less than 1%) of the average largest cross-sectional diameter of the cavities in the matrix.

In embodiments in which an optical material comprises a matrix and an array comprising a plurality of cavities disposed within the matrix, the average nearest neighbor distance between the cavities may be any suitable value. The average nearest neighbor distance between cavities may be greater than or equal to 10 nm, greater than or equal to 20 nm, greater than or equal to 50 nm, greater than or equal to 100 nm, greater than or equal to 200 nm, or greater than or equal to 500 nm. The average nearest neighbor distance between cavities may be less than or equal to 1 micron, less than or equal to 500 nm, less than or equal to 200 nm, less than or equal to 100 nm, less than or equal to 50 nm, or less than or equal to 20 nm. Combinations of the above-referenced ranges are also possible (e.g., greater than or equal to 10 nm and less than or equal to 1 micron). Other ranges are also possible. As used herein, the average nearest neighbor distance between cavities is the average, over all of the cavities in the plurality of cavities, of the distance between the center of each cavity and the center of its nearest neighbor. A cavity's nearest neighbor is the cavity for which the shortest line segment may be drawn from the center of the cavity to the center of the nearest neighbor cavity. The average nearest neighbor distance may be determined by microscopy.

In embodiments in which an optical material comprises a matrix and an array comprising a plurality of cavities disposed within the matrix, the standard deviation of the nearest neighbor distance between cavities may be any suitable value. The standard deviation of the nearest neighbor distance between the cavities may be greater than or equal to 0 nm, greater than or equal to 1 nm, greater than or equal to 2 nm, greater than or equal to 5 nm, greater than or equal to 10 nm, or greater than or equal to 20 nm. The standard deviation of the nearest neighbor distance between the cavities may be less than or equal to 30 nm, less than or equal to 20 nm, less than or equal to 10 nm, less than or equal to 5 nm, less than or equal to 2 nm, or less than or equal to 1 nm. Combinations of the above-referenced ranges are also possible (e.g., greater than or equal to 0 nm and less than or equal to 30 nm). Other ranges are also possible. As used herein, the standard deviation of the largest cross-sectional diameter of the cavities is the standard deviation of the largest cross-sectional diameter of the cavities, where the largest cross-sectional diameter of the cavities is the largest cross-sectional diameter of the cavities described above. The standard deviation of the nearest neighbor distance may be determined by performing statistical analysis of micrographs.

According to certain embodiments, the standard deviation of the nearest neighbor distances of the cavities in the matrix can be less than 10% (or less than 5%, or less than 2%, or less than 1%) of the average nearest neighbor distance between the cavities in the matrix.

In embodiments in which an optical material comprises a matrix and an array comprising a plurality of cavities disposed within the matrix, the cavities may comprise any suitable material. In some embodiments, at least a portion of the plurality of cavities may comprise and/or be filled by a gas, such as air. In some embodiments, at least a portion of the plurality of cavities may comprise and/or be filled with a liquid, such as water and/or an organic solvent. In some embodiments, at least a portion of the plurality of cavities may comprise and/or be filled with a solid, such as a polymer and/or a metal oxide. Each cavity within a plurality of cavities may comprise and/or be filled with the same material, and/or two or more cavities within a plurality of cavities may comprise and/or be filled with different materials.

As described above, certain embodiments relate to optical materials that comprise a matrix. When present, the matrix may have any suitable design. In some embodiments, the matrix may have a thickness that results in advantageous optical properties. For instance, matrices with thicknesses above certain minimum values may have enhanced absorbance and/or emittance at desired wavelengths (e.g., wavelengths lower than a spectral cutoff of the optical material, wavelengths corresponding to photons with energy larger than a bandgap of a photovoltaic material to which the optical material is coupled). The thickness of the matrix may be greater than or equal to 1 micron, greater than or equal to 2 microns, greater than or equal to 5 microns, greater than or equal to 10 microns, greater than or equal to 20 microns, greater than or equal to 50 microns, greater than or equal to 100 microns, greater than or equal to 200 microns, or greater than or equal to 500 microns. The thickness of the matrix may be less than or equal to 1000 microns, less than or equal to 500 microns, less than or equal to 200 microns, less than or equal to 100 microns, less than or equal to 50 microns, less than or equal to 20 microns, less than or equal to 10 microns, less than or equal to 5 microns, or less than or equal to 2 microns. Combinations of the above-referenced ranges are also possible (e.g., greater than or equal to 1 micron and less than or equal to 1000 microns, or greater than or equal to 1 micron and less than or equal to 100 microns). Other ranges are also possible. The thickness of the matrix may be determined by microscopy.

In some embodiments, an optical material may comprise a matrix that has a relatively low root mean square surface roughness. Matrices with low values of root mean square surface roughness may advantageously exhibit enhanced absorptivity when present in an optical material that is configured to act as a component of an absorber, and/or exhibit enhanced reflectivity when configured to act as a component of an emitter. A matrix may have a root mean square surface roughness of less than or equal to 50 nm, less than or equal to 40 nm, less than or equal to 30 nm, less than or equal to 20 nm, or less than or equal to 10 nm. A matrix may have a root mean square surface roughness of greater than or equal to 5 nm, greater than or equal to 10 nm, greater than or equal to 20 nm, greater than or equal to 30 nm, or greater than or equal to 40 nm. Combinations of the above-referenced ranges are also possible (e.g., less than or equal to 50 nm and greater than or equal to 5 nm). Other ranges are also possible. The root mean square roughness of a matrix may be determined by atomic force microscopy.

In some embodiments, an optical material may comprise a matrix that is configured to be stable at high temperatures for appreciable periods of time. A matrix with this property may be capable of being annealed at an elevated temperature for a period of time that allows appreciable improvements in one or more structural properties of the matrix (such as density, root mean square surface roughness, and/or crystallinity), without undergoing significant degradation. In certain cases, a matrix that is stable at high temperatures for appreciable periods of time may be capable of operating at high temperatures. This may be advantageous in the case of, for example, an optical material that is a component of an emitter. The matrix may be configured to be stable at a temperature of greater than or equal to 1000° C., greater than or equal to 1500° C., greater than or equal to 2000° C., or greater than or equal to 2500° C. The matrix may be configured to be stable at a temperature of less than or equal to 3000° C., less than or equal to 2500° C., less than or equal to 2000° C., or less than or equal to 1500° C. Combinations of the above-referenced ranges are also possible (e.g., greater than or equal to 1000° C. and less than or equal to 3000° C.). Other ranges are also possible.

In some embodiments, a matrix may be configured to be stable (e.g., at a temperature in one or more of the ranges above) for a period of time of greater than or equal to 168 hours, greater than or equal to 175 hours, greater than or equal to 200 hours, greater than or equal to 250 hours, greater than or equal to 300 hours, greater than or equal to 500 hours, greater than or equal to 1000 hours, or greater than or equal to 1500 hours. The matrix may be configured to be stable (e.g., at a temperature in one or more of the ranges above) for a period of time of less than or equal to 1680 hours, less than or equal to 1500 hours, less than or equal to 1000 hours, less than or equal to 500 hours, less than or equal to 300 hours, less than or equal to 250 hours, less than or equal to 200 hours, or less than or equal to 175 hours. Combinations of the above-referenced ranges are also possible (e.g., greater than or equal to 168 hours and less than or equal to 1680 hours). Other ranges are also possible.

In some embodiments, a matrix may be considered to be stable if the absorbance at wavelengths higher than the cutoff wavelength (e.g., wavelengths over which the optical material is configured to absorb, as described elsewhere herein) decreases by less than 10% of the maximum value of absorbance at these wavelengths. In some embodiments, a matrix may be considered to be stable if the absorbance at wavelengths higher than the cutoff wavelength (e.g., wavelengths over which the optical material is configured to absorb, as described elsewhere herein) increases by less than 10% of the maximum value of absorbance at these wavelengths.

In some embodiments, as described above, matrix may comprise a collection of elongated nanostructures. The elongated nanostructures may provide several advantages to the matrix. For instance, the elongated nanostructures may be capable of being formed facilely in at desired locations, such as in a pattern (e.g., in a periodic pattern). As another advantage, elongated nanostructures may also be capable of being formed in structures that have advantageous thicknesses, such as those described above. The thicknesses may be larger than those of matrices capable of being formed by other methods, and/or may allow for increased interaction time between the photons and the photonic crystal, resulting in better control over the ranges of wavelengths emitted and/or absorbed. As a third advantage, elongated nanostructures may be capable of serving as a material onto which another desirable material, such as a refractory material, may be deposited. Certain desirable materials that may be deposited onto a collections of elongated nanostructures may be challenging to form in structures with desirable morphologies in other ways, and/or may be formed into structures with desirable morphologies only with the use of difficult, slow, and/or expensive processes (e.g., forming features serially, etching to form desirable morphologies) when they are not deposited on elongated nanostructures. In some embodiments, elongated nanostructures may be easily formed in desirable morphologies, and may template the formation of other desirable materials in those same desirable morphologies.

When present in a matrix, a collection of elongated nanostructures may have any suitable orientation within the matrix. In some embodiments, the elongated nanostructures in the collection may be vertically aligned (e.g., substantially vertically aligned). Elongated nanostructures within a plurality of elongated nanostructures are said to be substantially aligned with each other (e.g., substantially vertically aligned when substantially aligned with each other in a vertical direction) when at least 50% of the elongated nanostructures are aligned with their nearest neighbors within the plurality of elongated nanostructures. In some embodiments, at least 50%, at least 60%, at least 70%, at least 80%, or at least 90% of the elongated nanostructures are aligned with their nearest neighbors within the plurality of elongated nanostructures (e.g., substantially vertically aligned). First and second elongated nanostructures are said to be aligned with each other when, when one traces a first straight line from one end of the first nanostructure to the other end of the first nanostructure, and one traces a second straight line from one end of the second nanostructure to the other end of the second nanostructure, the lines are within 15° (or, in some cases, within 10°, within 5°, or within) 2° of parallel. An elongated nanostructure is said to be aligned in a vertical direction when, when one traces a first straight line from one end of the first nanostructure to the other end of the first nanostructure, and one traces a second straight line parallel to the thickness of the matrix in which the elongated nanostructure is positioned, the lines are within 15° (or, in some cases, within 10°, within 5°, or within 2°) of parallel.

When present, a collection of elongated nanostructures may have any melting point. The melting point of the collection of elongated nanostructures may be greater than or equal to 1800° C., greater than or equal to 2000° C., greater than or equal to 2250° C., greater than or equal to 2500° C., greater than or equal to 2750° C., greater than or equal to 3000° C., greater than or equal to 3250° C., greater than or equal to 3500° C., or greater than or equal to 3750° C. The melting point of the collection of elongated nanostructures may be less than or equal to 4000° C., less than or equal to 3750° C., less than or equal to 3500° C., less than or equal to 3250° C., less than or equal to 3000° C., less than or equal to 2750° C., less than or equal to 2500° C., less than or equal to 2250° C., or less than or equal to 2000° C. Combinations of the above-referenced ranges are also possible (e.g., greater than or equal to 1800° C. and less than or equal to 4000° C.). Other ranges are also possible. The melting point of the collection of elongated nanostructures may be determined by differential scanning calorimetry.

When present, a collection of elongated nanostructures may comprise any suitable types of nanostructures. The collection of elongated nanostructures may comprise carbon-based nanostructures, such as carbon nanotubes and/or carbon nanofibers. As used herein, the term “nanotube” is given its ordinary meaning in the art and refers to a substantially cylindrical molecule or nanostructure that is hollow. In some embodiments, the nanotube comprises a fused network of primarily six-membered aromatic rings. In some cases, nanotubes may resemble a sheet of graphite formed into a seamless cylindrical structure. It should be understood that the nanotube may also comprise rings or lattice structures other than six-membered rings. Typically, at least one end of the nanotube may be capped, e.g., with a curved or nonplanar aromatic group. Nanotubes may have a diameter of the order of nanometers and a length on the order of millimeters, or, on the order of tenths of microns, resulting in an aspect ratio greater than 100, 1000, 10,000, or greater. In some cases, the nanotube is a carbon nanotube. The term “carbon nanotube” refers to nanotubes comprising primarily carbon atoms and includes single-walled nanotubes (SWNTs), double-walled CNTs (DWNTs), multi-walled nanotubes (MWNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube). In some cases, the nanotube may have a diameter less than 1 μm, less than 100 nm, 50 nm, less than 25 nm, less than 10 nm, or, in some cases, less than 1 nm.

In some embodiments, a collection of elongated nanostructures may comprise metal oxide nanostructures, such as alumina nanofibers, titanium dioxide nanofibers, and/or zinc oxide nanowires.

In some embodiments, a collection of elongated nanostructures may comprise semiconductor nanostructures, such as silicon nanowires and/or germanium nanowires.

In some embodiments, a collection of elongated nanostructures may comprise ceramic nanostructures, such as gallium nitride nanowires.

As described above, in some embodiments, a matrix may comprise a coating material. In certain embodiments, a matrix may comprise two or more coating materials (e.g., a second coating material disposed on a first coating material, a second coating material disposed on a first coating material disposed on a collection of elongated nanostructures). When two or more coating materials are present, each coating material may be different (e.g., a second coating material may be different than a first coating material), or two or more coating materials may be the same. Non-limiting examples of suitable coating materials include metals, ceramics, and oxides (e.g., refractory metals, refractory ceramics, refractory oxides). In some embodiments, a coating material may comprise one or more of tungsten, molybdenum, ruthenium, titanium nitride, hafnium diboride, alumina, and titanium dioxide. As described in further detail below, in certain embodiments, two or more coating materials may be sequentially deposited (e.g., a first coating material may be deposited, and then a second coating material may be deposited on the first coating material).

In certain embodiments, a matrix may comprise a coating material that has a relatively high melting temperature. In other words, a coating material may be a refractory material, such as a refractory metal, a refractory ceramic, and/or a refractory oxide. The melting point of the coating material may be greater than or equal to 1800° C., greater than or equal to 2000° C., greater than or equal to 2250° C., greater than or equal to 2500° C., greater than or equal to 2750° C., greater than or equal to 3000° C., greater than or equal to 3250° C., greater than or equal to 3500° C., or greater than or equal to 3750° C. The melting point of coating material may be less than or equal to 4000° C., less than or equal to 3750° C., less than or equal to 3500° C., less than or equal to 3250° C., less than or equal to 3000° C., less than or equal to 2750° C., less than or equal to 2500° C., less than or equal to 2250° C., or less than or equal to 2000° C. Combinations of the above-referenced ranges are also possible (e.g., greater than or equal to 1800° C. and less than or equal to 4000° C.). Other ranges are also possible. The melting point of the coating material may be determined by differential scanning calorimetry.

As described above, certain embodiments may comprise a substrate (e.g., a substrate on which a matrix is disposed, a substrate on which an absorber is disposed, a substrate on which an emitter is disposed, a substrate positioned between an absorber and an emitter). When present, the substrate may comprise any suitable materials.

In some embodiments, a substrate may comprise metals, ceramics, and/or oxides (e.g., refractory metals, refractory ceramics, refractory oxides). In some embodiments, a substrate may comprise one or more of tungsten, molybdenum, ruthenium, titanium nitride, hafnium diboride, alumina, and titanium dioxide.

In certain embodiments, a substrate may comprise a material that has a relatively high melting temperature. In other words, a substrate may be a refractory material, such as a refractory metal, a refractory ceramic, and/or a refractory oxide. The melting point of the substrate, when present may be greater than or equal to 1800° C., greater than or equal to 2000° C., greater than or equal to 2250° C., greater than or equal to 2500° C., greater than or equal to 2750° C., greater than or equal to 3000° C., greater than or equal to 3250° C., greater than or equal to 3500° C., or greater than or equal to 3750° C. The melting point of the substrate may be less than or equal to 4000° C., less than or equal to 3750° C., less than or equal to 3500° C., less than or equal to 3250° C., less than or equal to 3000° C., less than or equal to 2750° C., less than or equal to 2500° C., less than or equal to 2250° C., or less than or equal to 2000° C. Combinations of the above-referenced ranges are also possible (e.g., greater than or equal to 1800° C. and less than or equal to 4000° C.). Other ranges are also possible. The melting point of the substrate may be determined by differential scanning calorimetry.

When present, a substrate may be any suitable thickness. The substrate may have a thickness of less than or equal to 1 mm, less than or equal to 500 microns, less than or equal to 200 microns, less than or equal to 100 microns, less than or equal to 50 microns, less than or equal to 20 microns, or less than or equal to 10 microns. The substrate may have a thickness of greater than or equal to 1 micron, greater than or equal to 10 microns, greater than or equal to 20 microns, greater than or equal to 50 microns, greater than or equal to 100 microns, greater than or equal to 200 microns, or greater than or equal to 500 microns. Combinations of the above-referenced ranges are also possible (e.g., greater than or equal to 1 micron and less than or equal to 1 mm, or greater than or equal to 1 micron and less than or equal to 100 microns). Other ranges are also possible. The thickness of the substrate may be determined by microscopy.

In some embodiments, a substrate may be present and may have a relatively high thermal conductivity. For instance, the substrate may have a thermal conductivity such that appreciable thermal gradients will not exist across the substrate for long periods of time (e.g., during operation of one or more optical materials disposed on the substrate, during operation of a photovoltaic or thermophotovoltaic material of which the substrate forms one part, during operation of a photovoltaic material to which an optical material disposed on the substrate is coupled).

As described above, in certain embodiments an optical material as described herein may have utility in a photovoltaic system, may be configured act as a component of a photovoltaic system, and/or may be a component of a photovoltaic system. In photovoltaic systems, electromagnetic radiation (e.g., sunlight) is absorbed by a photovoltaic material to generate electron-hole pairs. An optical material as described herein may be positioned between the electromagnetic radiation source and the photovoltaic material to absorb certain wavelengths of light that would result in undesirable effects if transmitted to the photovoltaic cell (e.g., undesirable heating) and/or to emit certain wavelengths of light that are desirable for the photovoltaic cell to absorb (e.g., wavelengths close to the bandgap of the photovoltaic cell). In some embodiments, an optical material as described herein may be coupled to a photovoltaic material within a photovoltaic system (e.g., it may be configured to emit light towards the photovoltaic material, it may be configured to absorb light that would otherwise be incident on the photovoltaic material).

As also described above, in certain embodiments an optical material as described herein may have utility in a thermophotovoltaic system, may be configured act as a component of a thermophotovoltaic system, and/or may be a component of a thermophotovoltaic system. In thermophotovoltaic systems, electromagnetic radiation (e.g., sunlight) is not absorbed directly by a photovoltaic material, but rather, is absorbed by an absorber. In some cases, the absorber can selectively emit and/or be thermally coupled to an emitter, which then thermally radiates electromagnetic radiation. The electromagnetic radiation emitted by the emitter can then be absorbed by a photovoltaic cell.

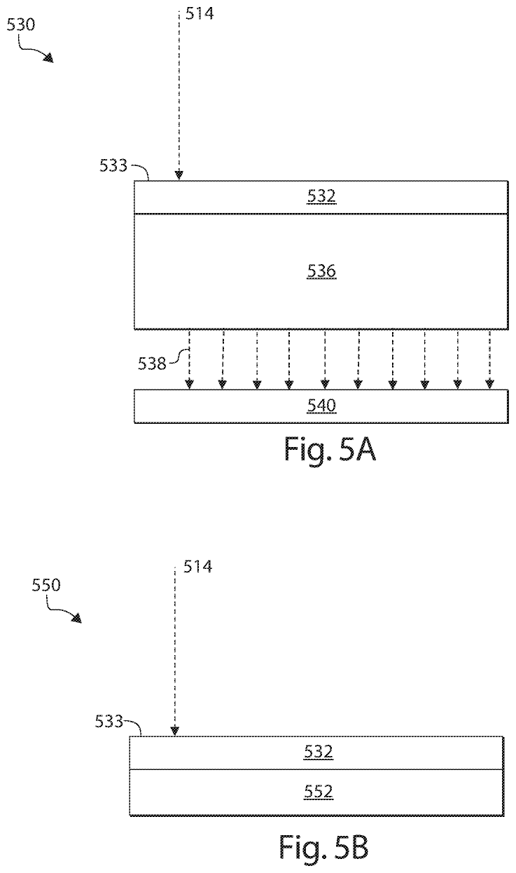

FIG. 5A includes an exemplary schematic diagram of a thermophotovoltaic energy generation system 530, according to one set of embodiments. In this set of embodiments, absorber 532 (e.g., absorber 10002 as shown in FIG. 4B) is configured to absorb electromagnetic radiation to generate heat. In this set of embodiments, electromagnetic radiation 514 (from a source such as the sun, which is not illustrated) is incident on incident surface 533 of absorber 532. At least a portion of electromagnetic radiation 514 (and, in some embodiments, a very high percentage of electromagnetic radiation) is absorbed by absorber 532.

Although selective absorber 532 and selective emitter 536 are illustrated as being in direct contact in FIG. 5A, in other embodiments, one or more materials (e.g., a thermally conductive material such as a metal) can be positioned between absorber 532 and emitter 536. Absorber 532 can be configured to transfer heat to emitter 536, for example, by placing the absorber and the emitter in direct contact, by positioning one or more heat exchangers between the absorber and the emitter, or by any other suitable method.

In some embodiments, emitter 536 is configured to emit electromagnetic radiation when it is heated. For example, emitter 536 can comprise a material having a relatively high emissivity (e.g., a material having an emissivity of at least about 0.7, at least about 0.8, or at least about 0.9, for example at the temperature at which the selective emitter is designed to operate and at the wavelength(s) of electromagnetic radiation the selective emitter is configured to radiate). Exemplary high emissivity materials include, but are not limited to, quartz, silicon carbon (e.g., graphite, carbon black, etc.), carbide, oxidized steel, and the like. In FIG. 5B, electromagnetic radiation 538 emitted from selective emitter 536 is absorbed by thermophotovoltaic cell 540, which generates energy (e.g., in the form of electricity).

In some embodiments, rather than heating an emitter, absorber 532 can be used to heat a working fluid, which can be used to power a heat engine. FIG. 5B is a schematic illustration of an energy generation system 550 in which absorber 532 is configured to provide heat to a working fluid within conduit 552. The fluid within conduit 552 can be a gas (e.g., to power a gas turbine or other energy generation device using gas as the working fluid) or a liquid (e.g., to power a steam turbine or other energy generation device in which the working fluid is a liquid at some point in the energy generation process).

Generally, thermophotovoltaic systems and heat engine-based systems are more efficient when they operate at high temperatures. In many previous systems, high temperatures can be achieved by using lenses, mirrors, or other suitable devices to focus the electromagnetic radiation (e.g., sunlight) onto the absorber. The selective emitters and absorbers described herein can be used to replace traditional concentrators in many such systems and/or enhance their effect, thereby improving system performance.

When configured to act as a component of an emitter, an optical material as described herein may be configured to emit light over any suitable wavelength range. The optical material may be configured to emit light with wavelengths greater than or equal to 1100 nm, greater than or equal to 1250 nm, greater than or equal to 1500 nm, greater than or equal to 1750 nm, greater than or equal to 2000 nm, greater than or equal to 2250 nm, greater than or equal to 2500 nm, greater than or equal to 2750 nm, or greater than or equal to 3000 nm. The optical material may be configured to emit light with wavelengths less than or equal to 3100 nm, less than or equal to 3000 nm, less than or equal to 2750 nm, less than or equal to 2500 nm, less than or equal to 2250 nm, less than or equal to 2000 nm, less than or equal to 1750 nm, less than or equal to 1500 nm, or less than or equal to 1250 nm. Combinations of the above-referenced ranges are also possible (e.g., greater than or equal to 1100 nm and less than or equal to 3100 nm). Other ranges are also possible. The wavelengths over which the emitter emits may be determined by UV-vis-NIR spectroscopy using variable angle spectral reflectance accessory. The amount of emission is equal to the product of the emissivity of the emitter and the blackbody radiation at the temperature at which the emitter is held.

In some embodiments, an emitter may have an emissivity of greater than or equal to 80%, greater than or equal to greater than or equal to 85%, greater than or equal to 90%, or greater than or equal to 95% at one or more wavelengths (e.g., wavelengths within a range described above, wavelengths below the cutoff wavelength). The emitter may have an emissivity of less than or equal to 100%, less than or equal to 95%, less than or equal to 90%, or less than or equal to 85% at one or more wavelengths (e.g., wavelengths within a range described above, wavelengths below the cutoff wavelength). Combinations of the above-referenced ranges are also possible (e.g., greater than or equal to 80% and less than or equal to 100%). Other ranges are also possible.

In some embodiments, an emitter may have an emissivity of greater than or equal to 0%, greater than or equal to greater than or equal to 5%, greater than or equal to 10%, greater than or equal to 15%, greater than or equal to 20%, or greater than or equal to 25% at one or more wavelengths (e.g., wavelengths outside a range described above, wavelengths above the cutoff wavelength). The emitter may have an emissivity of less than or equal to 30%, less than or equal to 25%, less than or equal to 20%, less than or equal to 15%, less than or equal to 10%, or less than or equal to 5% at one or more wavelengths (e.g., wavelengths outside a range described above, wavelengths above the cutoff wavelength). Combinations of the above-referenced ranges are also possible (e.g., greater than or equal to 0% and less than or equal to 30%). Other ranges are also possible.

An emitter comprising an optical material as described herein may be capable of exhibiting a high emission efficiency after being subject to an elevated temperature for an extended period of time. The emitter may be capable of exhibiting an emission efficiency of at least 5%, at least 10%, at least 15%, at least 20%, at least 25%, at least 30%, at least 35%, or at least 40% after being heated to a given temperature for a given period of time. The temperature may be a temperature of at least 1000 K, at least 1200 K, at least 1500 K, at least 2000 K, or at least 2500 K. The temperature may be at most 3000 K, at most 2500 K, at most 2000 K, at most 1500 K, or at most 1200 K. Combinations of the above-referenced ranges are also possible (e.g., at least 1000 K and at most 3000 K, or at least 1200 K and at most 3000 K). Other ranges are also possible.

The period of time over which the emission efficiency is determined may be at least 150 hours, at least 200 hours, at least 500 hours, at least 750 hours, at least 1000 hours, or at least 1250 hours. The period of time over which the emission efficiency is determined may be at most 1500 hours, at most 1250 hours, at most 1000 hours, at most 750 hours, at most 500 hours, or at most 200 hours. Combinations of the above-referenced ranges are also possible (e.g., at least 150 hours and at most 1500 hours). Other ranges are also possible.

The emission efficiency may be determined by solving the following equation for ηₑₘᵢₜₜₑᵣ:

$${η}_{emitter} = {\int }_{{E}_{g}}^{∞} \frac{{E}_{g}}{E} dE ɛ ( E ) {I}_{BB} ( E , T ) \text{/} {\int }_{0}^{∞} dE ɛ ( E ) {I}_{BB} ( E , T ) ,$$

where ε is the spectral emittance of the emitter, I_{BB} is the blackbody radiation at T, and E_{g} is 0.7 eV.

When configured to act as a component of an absorber, an optical material as described herein may be configured to absorb light over any suitable wavelength range. The absorber may be configured to absorb light with wavelengths greater than or equal to 800 nm, greater than or equal to 900 nm, greater than or equal to 1000 nm, greater than or equal to 1100 nm, greater than or equal to 1200 nm, greater than or equal to 1300 nm, or greater than or equal to 1400 nm. The absorber may be configured to absorb light with wavelengths less than or equal to 1500 nm, less than or equal to 1400 nm, less than or equal to 1300 nm, less than or equal to 1200 nm, less than or equal to 1100 nm, less than or equal to 1000 nm, or less than or equal to 900 nm. Combinations of the above-referenced ranges are also possible (e.g., greater than or equal to 800 nm and less than or equal to 1500 nm). Other ranges are also possible. The absorber may be configured to absorb light at wavelengths within the ranges listed above (e.g., at all wavelengths between 800 nm and 1500 nm) with an absorbance of greater than or equal to 0.85, greater than or equal to 0.9, greater than or equal to 0.95, greater than or equal to 0.975, greater than or equal to 0.99, or greater than or equal to 0.999. The absorber may be configured to absorb light at wavelengths within the ranges listed above (e.g., at all wavelengths between 800 nm and 1500 nm) with an absorbance of less than or equal to 1, less than or equal to 0.999, less than or equal to 0.99, less than or equal to 0.975, less than or equal to 0.95, or less than or equal to 0.9. Combinations of the above-referenced ranges are also possible (e.g., greater than or equal to 0.85 and less than or equal to 1). Other ranges are also possible. The wavelengths over which the absorber absorbs and the absorbance of the absorber at these wavelengths may be determined by UV-vis-NIR spectroscopy using variable angle spectral reflectance accessory.

An absorber comprising an optical material as described herein may be capable of exhibiting a high absorption efficiency after being subject to an elevated temperature for an extended period of time. The absorber may be capable of exhibiting an absorption efficiency of at least 80%, at least 85%, at least 90%, at least 95%, or 100% after being heated to a given temperature for a given period of time. The temperature may be a temperature of at least 1000 K, at least 1200 K, at least 1500 K, at least 2000 K, or at least 2500 K. The temperature may be at most 3000 K, at most 2500 K, at most 2000 K, at most 1500 K, or at most 1200 K. Combinations of the above-referenced ranges are also possible (e.g., at least 1000 K and at most 3000 K, or at least 1200 K and at most 3000 K). Other ranges are also possible.

The period of time over which the absorption efficiency is determined may be at least 150 hours, at least 200 hours, at least 500 hours, at least 750 hours, at least 1000 hours, or at least 1250 hours. The period of time over which the absorption efficiency is determined may be at most 1500 hours, at most 1250 hours, at most 1000 hours, at most 750 hours, at most 500 hours, or at most 200 hours. Combinations of the above-referenced ranges are also possible (e.g., at least 150 hours and at most 1500 hours). Other ranges are also possible.

The absorption efficiency may be determined by solving the following equation for η_{absorber}:

$${η}_{absorber} = ( 1 - \frac{T}{{T}_{a}} ) [ C {\int }_{solar} d λα ( λ ) {I}_{s} ( λ ) - {\int }_{BB} d λα ( λ ) {I}_{BB} ( λ , T ) ] \text{/} [ C {\int }_{solar} d λ {I}_{s} ( λ ) ]$$

where C is the number of suns, λ is the wavelength, Iₛ is the solar irradiance, I_{BB} is the blackbody radiation at T, Tₐ is the ambient temperature (300 K) and α is the spectral absorbance of the absorber.

As described above, in some embodiments a thermophotovoltaic material as described herein may further comprise a photovoltaic material (e.g., a photovoltaic material coupled to an optical material, a photovoltaic material coupled to an emitter, a photovoltaic material coupled to an absorber, a photovoltaic material coupled to a composite material). The bandgap of the photovoltaic material may be greater than or equal to 0.3 eV, greater than or equal to 0.5 eV, greater than or equal to 0.75 eV, or greater than or equal to 1 eV. The bandgap of the photovoltaic material may be less than or equal to 1.1 eV, less than or equal to 1 eV, less than or equal to 0.75 eV, or less than or equal to 0.5 eV. Combinations of the above-referenced ranges are also possible (e.g., greater than or equal to 0.3 eV and less than or equal to 1.1 eV). Other ranges are also possible. The bandgap of the photovoltaic material may be determined by UV-vis-NIR spectroscopy using variable angle spectral reflectance accessory.

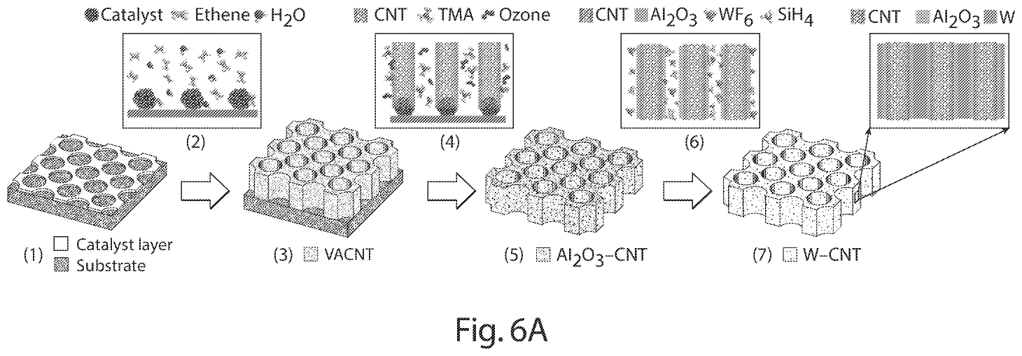

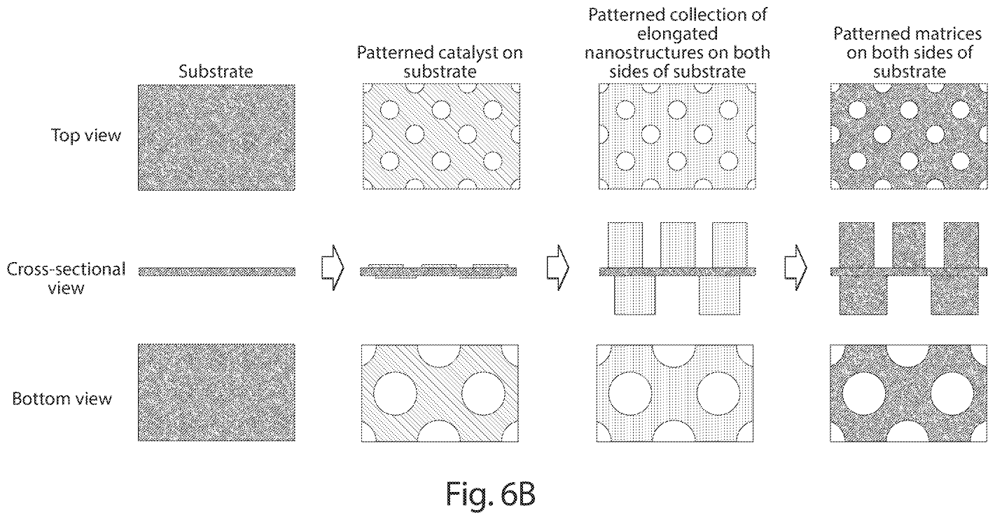

As described above, certain embodiments described herein are related to methods of making optical materials. An exemplary method of making an optical material is described below and shown in FIG. 6A. It should be understood that methods as described herein may comprise each step in FIG. 6A, a portion of the steps shown in FIG. 6A (e.g., steps 5 and 6 but not 1-4 or 7), may comprise none of the steps shown in FIG. 6A, and/or may comprise additional steps not shown in FIG. 6A.

In FIG. 6A, the first step shown is a step of providing a catalyst on a substrate. The catalyst may be positioned on the substrate in locations at which it would be desirable to form a portion of a matrix, such as a collection of elongated nanostructures. For instance, the catalyst may be positioned on the substrate in pattern, such as a periodic pattern.

The second step shown in FIG. 6A comprises forming a collection of elongated nanostructures on the catalyst. For instance, the elongated nanostructures may be formed by growing the elongated nanostructures on the catalyst. At the conclusion of this step, a collection of elongated nanostructures may be disposed on the catalyst. As shown in step 3 of FIG. 6A, the collection of elongated nanostructures may be present at locations on the substrate on which the catalyst is positioned, and may be absent from locations on the substrate at which the catalyst is absent. Judicious positioning of the catalyst at desired locations may thus result in the formation of the collection of elongated nanostructures in these same desired locations. It should be noted that although FIG. 6A shows growth of the collection of elongated nanostructures from ethylene precursors in an environment that comprises water vapor, other growth precursors and/or environments may be employed in some embodiments.

The fourth step shown in FIG. 6A comprises depositing a coating material on the collection of nanostructures grown in step 2. The coating material shown in FIG. 6A, alumina, is grown using atomic layer deposition of trimethylaluminum and ozone. However, other growth methods may be employed and/or other coating materials may be grown in some embodiments. At the conclusion of the fourth step, a matrix comprising a collection of elongated nanostructures at least partially coated by a coating material is achieved, as shown in step 5.

The fifth step shown in FIG. 6A comprises depositing a second coating material on the coating material. In certain cases, forming two coating materials may be desirable. The second coating material, such as the coating material formed in step 6 in FIG. 6A, may be a coating material that is advantageous for one or more reasons (e.g., it may have desirable stability at elevated temperatures for appreciable lengths of time, it may have desirable optical properties, and/or it may protect one or more components of the matrix such as the collection of elongated nanostructures and/or the first coating material from contaminants and/or oxidizing agents). However, it may be incompatible with the collection of elongated nanostructures. For instance, the second coating material may be undesirably reactive with the collection of elongated nanostructures. In such embodiments, it may be advantageous to deposit a first coating material on the collection of elongated nanostructures prior to depositing the second coating material (e.g., as shown in step 4 of FIG. 6A). The first coating material may be compatible with both the collection of elongated nanostructures and the second coating material. In such cases, when the first coating material at least partially (e.g., fully, in certain embodiments) coats the collection of elongated nanostructures, it may reduce the extent of and/or prevent a chemical reaction between the collection of elongated nanostructures and the second coating material. Thus, it may allow the use of certain elongated nanostructures in combination with a desirable coating material with which they would otherwise be incompatible. One exemplary pair of first and second coating materials is alumina and tungsten (e.g., alumina disposed may be disposed on carbon nanotubes, and tungsten may be disposed on the alumina disposed on the carbon nanotubes) After the completion of step 6, the final optical material is obtained (e.g., in step 7).

It should be noted that although FIG. 6A, depicts a second coating material that is tungsten and is formed by reaction of WF₆ and SiH₄ during chemical vapor deposition, other second coating materials and methods of fabricating second coating materials are also contemplated.

In some embodiments, an annealing step may be performed after the steps shown in FIG. 6A.

In some embodiments, two or more optical materials may be formed on a substrate simultaneously. For instance, a patterned catalyst may be formed on two opposing sides of the substrate (e.g., by employing one or more of the steps described with respect to FIG. 6A). Then, collections of elongated nanostructures may be grown from the patterned catalyst on both opposing sides of the substrate (e.g., simultaneously), the collection of nanostructures on both opposing sides of the substrate may be coated with one or more materials, (e.g., simultaneously) and/or an annealing step may be performed (e.g., on the composite material as a whole). FIG. 6B shows one non-limiting embodiment of a method of forming a first optical material on a first side of a substrate while simultaneously forming a second optical material on a second, opposing, side of the same substrate. It should be understood that the steps described with respect to FIG. 6A can be used to form portions of the composite material shown in FIG. 6B. For instance, a substrate on which a patterned catalyst is disposed on two opposing sides may be suspended and exposed to a precursor material for the elongated nanostructures; the elongated nanostructures may grow simultaneously from both opposing sides of the substrate. As another example, a substrate may be suspended and one or more coating processes may be performed such that both sides of the substrate are coated simultaneously. In other words, a coating may be deposited on two collections of nanostructures disposed on opposing sides of a substrate simultaneously. Other methods of forming nanostructures on both sides of a substrate are also contemplated.

As described above, in certain embodiments, a method of making an optical material comprises forming a collection of elongated nanostructures on an catalyst positioned on a substrate. As also described above, the catalyst may be positioned on certain portions of the substrate, and other portions of the substrate may not comprise any catalyst thereon. The catalyst may be selectively positioned on certain portions of a substrate by providing a substrate which is fully covered by the catalyst, and then selectively removing the catalyst from certain portions of the substrate. In other words, a method may comprise removing one or more portions of an catalyst from a substrate on which the catalyst is disposed. The one or more portions removed may form a pattern, such as a periodic pattern.

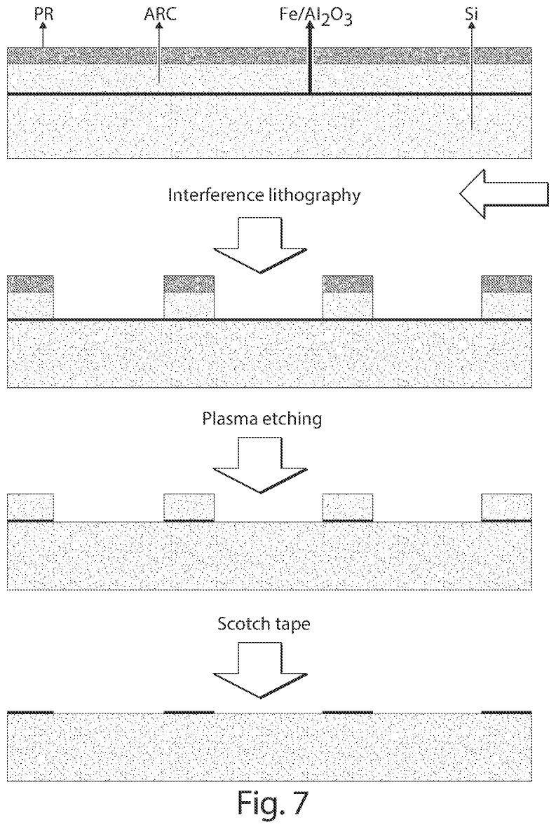

In some embodiments, an catalyst may be selectively removed from certain portions of a substrate by an interference lithography process. The catalyst may be a catalyst that was deposited onto the substrate by a method such as electron beam deposition. FIG. 7 shows one non-limiting embodiment of an interference lithography process, in which a substrate (e.g., a silicon substrate, as in FIG. 7) initially fully covered by the catalyst (e.g., iron, as in FIG. 7; in FIG. 7, the iron catalyst is disposed on an alumina layer on the silicon substrate) is transformed into a substrate on which the catalyst may be positioned on certain portions and for which other portions do not comprise any catalyst thereon. Initially, the catalyst is also covered by one or more photoresists (e.g., PR in FIG. 7). Optionally, as shown in FIG. 7, an antireflection coating may be positioned between the photoresist and the catalyst in order to reduce the light reflected back from the substrate into the photoresist layer.

During an interference lithography process, a photoresist-coated substrate is exposed to light of spatially varying intensity (e.g., a periodic pattern produced by two or more interfering laser beams, such as HeCd laser beams, and/or using a system such as a Lloyd's mirror system). In the case of a negative photoresist, regions exposed to higher intensities of light undergo chemical reactions that reduce their resistance to etching (in the case of a positive photoresist, regions exposed to higher intensities of light undergo chemical reactions that increase their resistance to etching). After exposure to light of spatially varying intensity, portions of the photoresist may be removed, (e.g., portions of a negative photoresist exposed to higher intensities of light, portions of a positive photoresist not exposed to higher intensities of light), such as by etching (e.g., plasma etching, He—O₂ reactive ion etching). Portions of the photoresist not removed may protect catalyst therebeneath from etching, while exposed portions of the catalyst may be removed (e.g., by etching, by using the same etchant employed to selectively etch the photoresist). In other words, the catalyst exposed by the removal of the photoresist may be etched, while catalyst not exposed by the removal of the photoresist may remain unetched. Finally, the remaining photoresist may be removed, e.g., with scotch tape and/or using an asher. At the conclusion of the process described above, a catalyst disposed on selected portions of the substrate is obtained (e.g., portions beneath photoresist that was not removed during the initial removal process).

The substrate may be any suitable material. In some embodiments, the substrate may comprise a semiconductor, such as silicon. In some embodiments, the substrate may comprise a ceramic, such as titanium nitride and/or silicon nitride. In some embodiments, the substrate may comprise one or more of the substrate materials described elsewhere herein.

The catalyst may be any material capable of catalyzing growth of elongated nanostructures. The catalyst may be selected to have high catalytic activity and optionally the ability to be regenerated after growth of a set of elongated nanostructures. The catalyst may also be selected to be compatible with the substrate such that the catalyst may be deposited or otherwise formed on the surface of the substrate. For example, the catalyst may be selected to have a suitable thermal expansion coefficient as the substrate to reduce or prevent delamination or cracks. The catalyst may be positioned on or in the surface of the substrate

Materials suitable for use as the catalyst include metals, for example, a Group 1-17 metal, a Group 2-14 metal, a Group 8-10 metal, or a combination of one or more of these. Elements from Group 8 that may be used in the present invention may include, for example, iron, ruthenium, or osmium. Elements from Group 9 that may be used in certain embodiments may include, for example, cobalt, rhenium, or iridium. Elements from Group 10 that may be used in the present invention may include, for example, nickel, palladium, or platinum. In some cases, the catalyst is iron, cobalt, or nickel. In an illustrative embodiment, the catalyst may be iron nanoparticles, or precursors thereof, arranged in a pattern on the surface of the growth substrate. The catalyst may also be other metal-containing species, such as metal oxides, metal nitrides, etc. Those of ordinary skill in the art would be able to select the appropriate catalyst to suit a particular application.

Optionally, as shown in FIG. 7, the catalyst may be provided on a buffer layer that is positioned between the substrate and the catalyst. The buffer layer may prevent diffusion of the catalyst into the substrate.

In some cases, elongated nanostructures may be synthesized using an appropriate combination of precursors and/or catalysts, by delivering sequential exclusive reactant streams (e.g., comprising precursors), or by using a mixed reactant stream which causes growth of multiple types of elongated nanostructures, and which is selective to the nature (e.g., elemental composition and size) of the catalyst arranged on the substrates.

The catalyst may be formed on the surface of the substrate using various methods, including growth from one or more gaseous precursors (e.g., by chemical vapor deposition), for example. A coating of an catalyst on the substrate may comprise metal nanoparticles (e.g., Fe, Co, and/or Ni) for growth of elongated nanostructures such as carbon nanotubes from the surface of the substrate, or may be precursors to the formation of the catalyst.

Other methods may be used to deposit the catalyst on the substrate, such as Langmuir-Blodgett techniques, deposition from solutions of pre-formed nanoparticles such as ferrofluids, and deposition from solutions of metal salts which coat the substrate and decompose to form nanoparticles when heated (e.g., metal nitrates decompose at 150-190° C.). In some cases, block copolymers may be used to template the organization catalyst material on the growth substrate.

As described herein, the a collection of elongated nanostructures may be synthesized by contacting a precursor material with an catalyst, for example, positioned on the surface of the substrate. In some embodiments, the precursor material may be a nanotube precursor material and may comprise one or more fluids, such as a hydrocarbon gas, hydrogen, argon, nitrogen, combinations thereof, and the like. Those of ordinary skill would be able to select the appropriate precursor material to produce a particular elongated nanostructure. For example, carbon nanotubes may be synthesized by reaction of a C₂H₄/H₂ mixture with a catalyst material, such as nanoparticles of Fe arranged on an Al₂O₃ support. The synthesis of nanotubes is described herein by way of example only, and it should be understood that other elongated nanostructures may be fabricated using methods described herein. For example, nanowires or other structures having high aspect ratio may be fabricated using growth substrates as described herein. For example, nanostructures having an aspect ratio of at least 10:1, at least 100:1, at least 1000:1, or, in some cases, at least 10,000:1, may be fabricated. In one set of embodiments, methods of the invention may be used to synthesize nanostructures having a diameter of less than 100 nanometers and a length of at least 1 micron. Those of ordinary skill in the art would be able to select the appropriate combination of precursor materials, catalysts, and set of conditions for the growth of a particular nanostructure.

The precursor material may be introduced into the system and/or growth substrate by various methods. For example, a flow of precursor material may be introduced in a direction substantially perpendicular to the surface of the substrate, or, in a continuous method, in the direction of movement of the growth substrate through the system. The substrate may be moved at a particular rate along its axial direction, while a flow of nanostructure precursor material may impinge on the substrate in a direction perpendicular to substrate motion. In some cases, as the substrate is moved through the apparatus, the catalyst may cause nucleation of a layer of aligned nanostructures, which may increase in thickness as the substrate moves through the growth apparatus.

As used herein, a “precursor material” refers to any material or mixture of materials that may be reacted to form a nanostructure under the appropriate set of conditions. The nanostructure precursor material may comprise a carbon-containing species (e.g., hydrocarbons such as C₂H₄ and CH₄, alcohols, etc.), one or more fluids (e.g., gases such as H₂, O₂, helium optionally comprising water, argon, nitrogen, etc.), or other chemical species that may facilitate formation of elongated nanostructures.

Depositing a coating material (e.g., on a collection of elongated nanostructures) may be accomplished by any suitable process. In some embodiments, one or more of the following processes may be employed: atomic layer deposition, formation of the coating material from one or more gaseous precursors, a chemical vapor deposition process, and a physical vapor deposition process.

When performed, an annealing step may take any suitable amount of time. The annealing step may be performed over a period of time of greater than or equal to 1 hour, greater than or equal to 2 hours, greater than or equal to 6 hours, greater than or equal to 12 hours, greater than or equal to 1 day, greater than or equal to 2 days, greater than or equal to 3 days, greater than or equal to 5 days, greater than or equal to 1 week, or greater than or equal to 1.5 weeks. The annealing step may be performed over a period of time of less than or equal to 2 weeks, less than or equal to 1.5 weeks, less than or equal to 1 week, less than or equal to 5 days, less than or equal to 3 days, less than or equal to 2 days, less than or equal to 1 day, less than or equal to 12 hours, less than or equal to 6 hours, or less than or equal to 2 hours. Combinations of the above-referenced ranges are also possible (e.g., greater than or equal to 1 hour and less than or equal to 2 weeks). Other ranges are also possible.

When performed, an annealing step may be performed at any suitable temperature. References herein to temperature should be understood to refer to temperatures of the ambient environment during annealing (e.g., in air surrounding the matrix, in an inert gas surrounding the matrix), temperatures of a substrate on which the matrix is disposed during annealing, and/or temperatures of the matrix during annealing. It should also be understood that references herein to temperature refer to temperatures present at any point in time during annealing, temperatures present for any fraction of the total annealing time, and/or temperatures present throughout annealing. The temperature may be greater than or equal to 800° C., greater than or equal to 850° C., greater than or equal to 900° C., or greater than or equal to 950° C. The temperature may be less than or equal to 1000° C., less than or equal to 950° C., less than or equal to 900° C., or less than or equal to 850° C. Combinations of the above-referenced ranges are also possible (e.g., greater than or equal to 800° C. and less than or equal to 1000° C.). Other ranges are also possible.

Annealing may be performed in any suitable atmosphere. In some embodiments, annealing is performed under vacuum (e.g., under a vacuum of approximately 10⁻³ Torr) and/or under a flow of one or more inert gases (e.g., under a flow of 100 sccm He).

In one embodiment, thermophotovoltaic systems, materials for use in thermophotovoltaic systems, and associated methods are provided.

Solar thermophotovoltaic (STPV) systems rely on an engineered nanophotonic absorber/emission surface to convert broadband sunlight to narrow-band thermal emission for band-matching photovoltaics, in some embodiments. In certain cases, the engineered nanophotonic layer is composed of periodically arrays of nanocavities, which can tailor thermal radiation. Recent research has focused on absorber/emitter fabrication by nanopatterning of refractory metals based on lithography and lengthy reactive ion etching processes. The manufacturing complexity significantly limits the scalability of nanophotonic absorber/emission surfaces in some STPV systems.

Generally, current STPV systems use band-matching photovoltaic cells with bandgaps of 0.3 to 0.5 eV, resulting in a power conversion efficiency (PCE) of less than 3%. To further improve the PCE, band-matching cells with larger bandgaps are sometimes required, which would eventually require much higher operating temperatures for the nanophotonic absorber/emission surfaces in certain cases. In some systems, refractory metal-based nanophotonic surfaces suffer from severe surface diffusion and structural degradation, causing loss of selectivity in solar absorption and thermal emission. Thus, in some cases, the long-term thermal stability at high temperatures is another issue that limits the widespread applications of STPV systems.

Carbon nanotubes (CNTs) are potentially attractive for use in TPV systems because of their high melting temperature (exceeding 3,500 K under inert atmosphere) and surface stability. Moreover, CNTs can be manufactured by scalable chemical vapor deposition (CVD) methods. According to certain embodiments, a tungsten-CNT nanostructure, where CNTs serve as scaffold to maintain the integrity of the nanostructure at high temperatures is proposed. Some technical challenges related to nanoscale patterning of catalysts and nanoscale density control of CNT arrays exist.

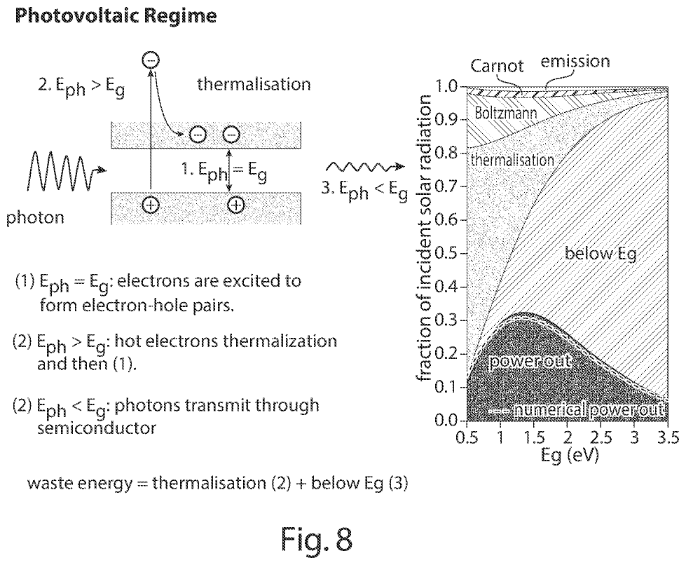

In the photovoltaic regime, a photon impinging on a photovoltaic device can be considered to have an energy Eₚₕ and the bandgap of the photovoltaic device may be considered to have an energy E_{g}. When parametrized in this way, there are three types of photons that may impinge on a photovoltaic device (see FIG. 8). For the first type of photon, Eₚₕ=E_{g}; such photons excite electrons in the photovoltaic device to form electron-hole pairs. For the second type of photon, Eₚₕ>E_{g}; such photons result in hot electrons that undergo thermalization to form electrons with the same energy as electrons formed by the first type of photon. For the third type of photon, Eₚₕ<E_{g}; such photons are transmitted through the photovoltaic device (e.g., through a semiconductor photovoltaic device). Photons that are of either the second type or the third type result in undesirable waste energy.

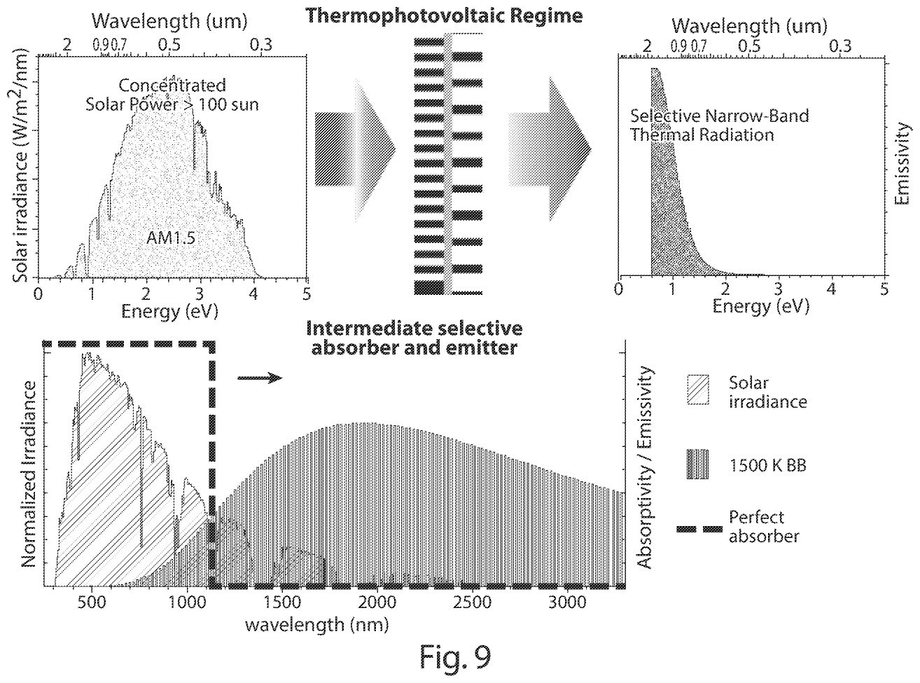

It may be desirable, in certain circumstances, for photovoltaic devices to be exposed to light at wavelengths that will result in reduced amounts of waste energy. This may be accomplished, for example, by including a selective absorber to absorb one or more wavelengths of light (e.g., all wavelengths of light, wavelengths of light that would result in a large amount of waste energy) and/or a selective emitter to emit light at an advantageous range of wavelengths (e.g., wavelengths at or near the bandgap of the photovoltaic device, wavelengths that result in little or no waste energy). FIG. 9 shows an example of how a combination of a selective absorber and a selective emitter positioned between a source of radiation (e.g., a source that emits a spectrum of wavelengths similar to the sun) and a photovoltaic device may absorb certain wavelengths to which it is exposed and emit certain wavelengths towards the photovoltaic device in order to reduce the waste energy of the photovoltaic device. FIG. 9 also shows a range of desirable wavelengths that could be absorbed by a perfect absorber, and the emittance of a blackbody radiator at 1500 K.

U.S. Provisional Patent Application No. 62/426,793, filed Nov. 28, 2016, and entitled “Nanopatterned Carbon Nanotube Surfaces for Stable Selective Emitters in Thermophotovoltaics,” is incorporated herein by reference in its entirety for all purposes.

The following examples are intended to illustrate certain embodiments of the present invention, but do not exemplify the full scope of the invention.

### Example 1

In this Example, the use of nanostructures comprising tungsten-coated carbon nanotube photonic crystals is proposed for high temperature selective layers. Strategies to overcome technical challenges associated with nanoscale patterning of carbon nanotube catalysts to form photonic crystals with appropriate structures for selective absorbers and selective emitters are also described.

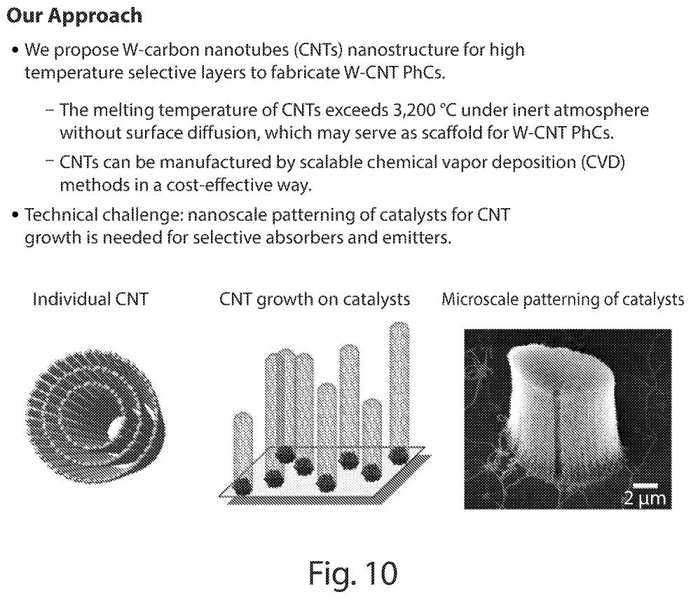

Tungsten-coated carbon nanotubes (W-CNTs) may be desirable for use in photonic crystals for several reasons. The melting temperature of CNTs exceeds 3200° C. under inert atmosphere, and surface diffusion of CNTs is minimal. The CNTs may serve as a scaffold onto which tungsten can be coated to form W-CNT PhCs. CNTs can be manufactured by scalable chemical vapor deposition (CVD) methods in a cost-effective way. FIG. 10 shows an overview of the approach employed in this Example.

Fabrication and characterization of nanopatterned W-CNT surface, with 500 nm diameter cylindrical cavities and 650 nm spacing, were carried out. The surface was designed using ab-initio FDTD calculations (physical parameters obtained from Lorentz-Drude model). The nanopatterned catalyst layer for CNT growth was realized using interference lithography. After the CNT growth, the nanopatterned CNT surface was coated with Al₂O₃ and W by atomic layer deposition (ALD). The thermal emission spectrum and thermal stability of the nanopatterned W-CNT surface were also investigated.

### 1. Methods and Materials

### 2.1 Numerical Design of Nanopatterned W-CNT Surface

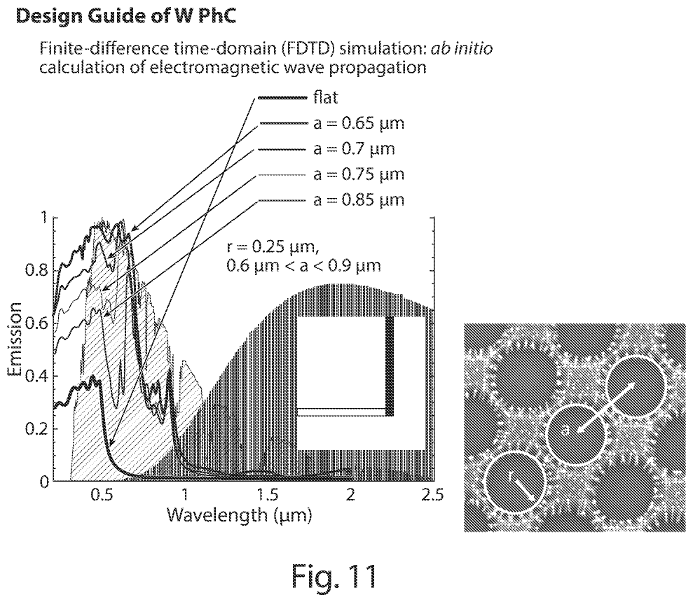

The nanophotonic surface is composed of 2D square array of nanocavities with period a, diameter d, and depth t. The ideal nanophotonic surface absorber, in some cases, should only absorb photons above a cutoff energy. Such selectivity was achieved in this Example through resonant coupling of fundamental mode of the nanocavities. The nanophotonic surface was designed using ab-initio finite-difference time domain (FDTD) simulation, with the physical properties obtained from Lorentz-Drude model. Pure tungsten was used as reference material to guide the design of the optimal dimensions, owing to the lack of the critical physical properties of the W-CNT nanostructure. The cutoff frequency corresponds to the electronic bandgap of Si. The optimal parameters were obtained with 500 nm diameter cylindrical cavities and 650 nm spacing. In future work, to precisely design the nanopatterned W-CNT surface, the complex dielectric constant will be extracted from the reflectance spectra of the W-CNT nanostructure. Based on the simulation calibration, more systematic optimization and analysis of the W-CNT surfaces will be studied. FIG. 11 shows an example of the results of an FDTD simulation and an SEM image of a structure fabricated based on the results of an FDTD simulation.

### 2.2 Nanoscale Patterning of Catalysts

After the determination of the diameter of the cavities, the pitch distance between the cavities and the thickness of the surface, nanoscale patterning of catalysts for CNT growth was carried out using interference lithography-based method. To start with, a catalyst layer composed of Fe (1 nm) and Al₂O₃ (10 nm) was e-beam deposited on a <100> Si wafer. An anti-reflection coating (ARC) was spin coated on the substrate and then baked at 180° C. for 60 seconds. Subsequently, a negative photoresist layer was spin coated, followed by a bake at 150° C. for 60 seconds in the ambient. The bilayer stack on the Si wafer was then exposed twice to a HeCd laser (λ=325 nm, P=0.2 μW) using a Lloyd's mirror interference lithography system. The two exposures were perpendicular to each other, so that a periodic square array of cavities was formed. The period a is described by the following equation:

$$a = \frac{λ}{2 sin θ}$$

Where λ is the wavelength of the laser, and θ is the angle between the incident laser and the Lloyd's mirror. After developing the exposed photoresist, the ARC and the catalyst in the cavities was removed by He—O₂ based reactive ion etching. The etching thickness was only 10 nm, which required much less etching time (<5 min). Finally, the patterned substrate was cleaned by a plasma asher to remove remaining photoresist and ARC.

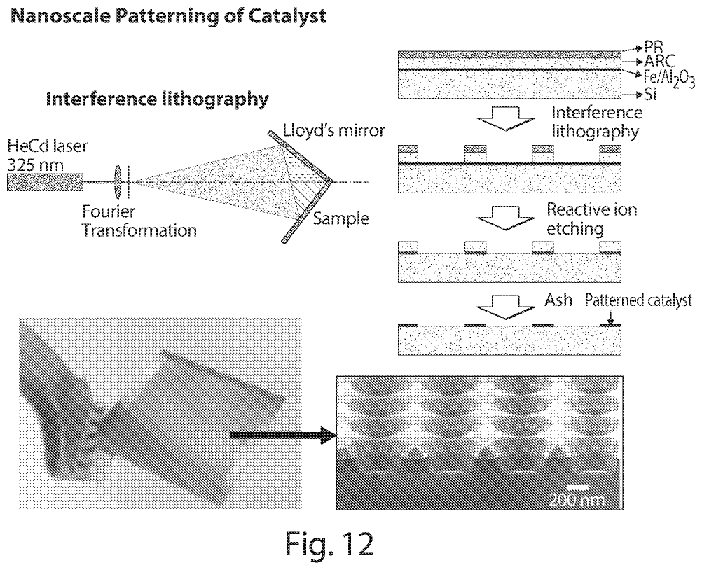

FIG. 12 shows an example of a method used to form a patterned catalyst on a substrate for use in patterned CNT growth, as well as optical and electron micrographs of the W-CNT coated substrate after CNT growth, alumina deposition, and tungsten deposition.

### 2.3 Synthesis of High Density CNT Array Using Automatic CVD System

The high-density CNT arrays were synthesized using atmospheric pressure chemical vapor deposition system. The catalyst was prepared by e-beam deposition of a 10-nm-thick Al₂O₃ buffer layer and a subsequent 1-nm-thick Fe catalyst layer. In a typical CNT synthesis procedure, an empty CVD chamber was heated to a target 750° C. while exposed to a hydrogen and helium flow mixture, followed by the introduction of C₂H₄ and wet helium for 5 min. This process resulted in the deposition of amorphous carbon layer on the CVD chamber. After flushing the chamber with a hydrogen and helium flow mixture, a transfer arm carrying the substrate loaded with patterned catalyst was inserted into the hot chamber. After annealing at 750° C. for 10 min, the substrate was retracted from the hot chamber. The carbon precursor—C₂H₄ and wet helium—was then flowed into the hot chamber. The substrate was inserted again after the stabilization of the carbon precursor flow. The typical growth rate of the CNT array is 2 μm/sec.

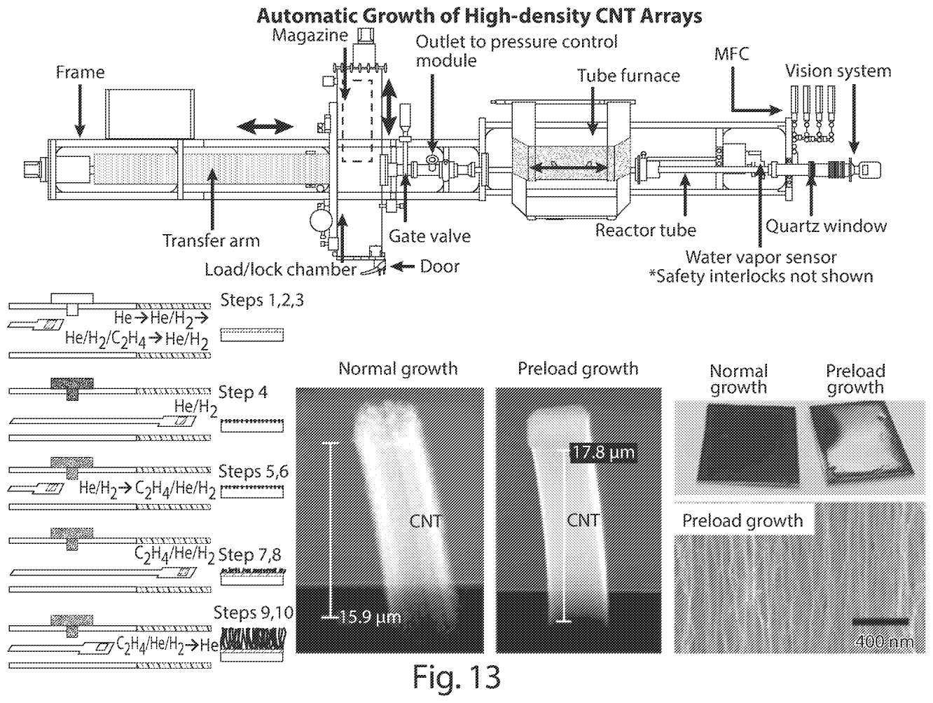

FIG. 13 shows a schematic of the system used to grow the carbon nanotubes, a method of growing the carbon nanotubes in the system, and micrographs showing carbon nanotubes grown with and without a preloading step.

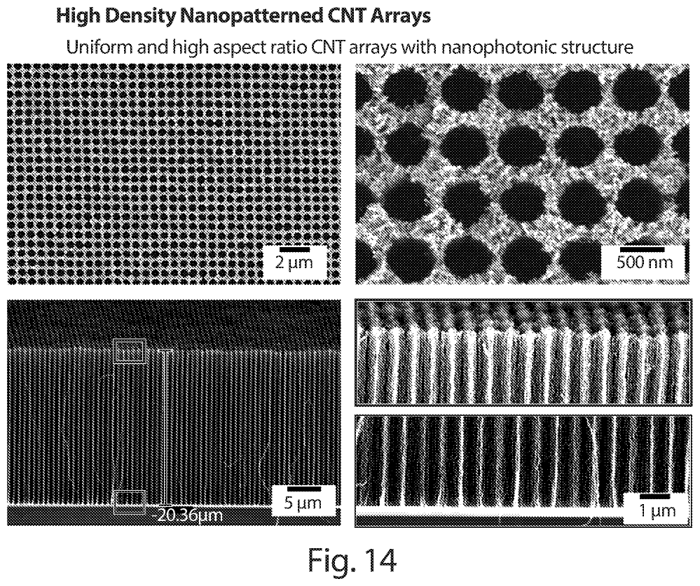

FIG. 14 shows micrographs of carbon nanotubes grown on a patterned catalyst.

### 2.4 Synthesis of High Density CNT Array Using Automatic CVD System

The atomic layer deposition (ALD) of tungsten was achieved by alternately pulsing diluted SiH₄ (2% in Ar) and WF₆ to the nanopatterned CNT arrays, followed by inert gas purge after each reagent pulsing. Typical precursor exposures in Langmuir (1 L=10-6 Toms) were approximately 6×10⁵ L, 5×10⁵ L, and 1×10⁷ L, for SiH₄, WF₆, and H₂, respectively. The typical deposition rate was approximately 1 nm/cycle. Before the W ALD, a very thin and conformal layer of Al₂O₃ was deposited on the nanopatterned CNT arrays using ALD. This thin Al₂O₃ layer could effectively prevent the reaction between W and CNT to form tungsten carbide. In this Experiment, 20 cycles of Al₂O₃ and 50 cycles of W ALDs were conducted consequently on the nanopatterned CNT arrays to form W-CNT surface.

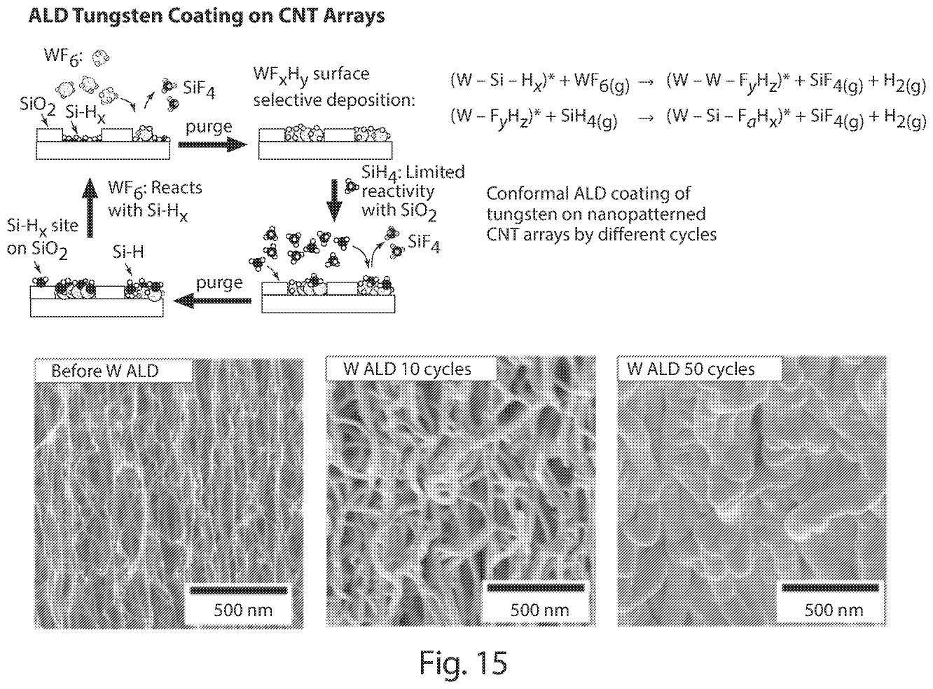

FIG. 15 shows a schematic of the process used to deposit tungsten on alumina-coated carbon nanotubes, and micrographs of alumina-coated carbon nanotubes formed by the process described above.

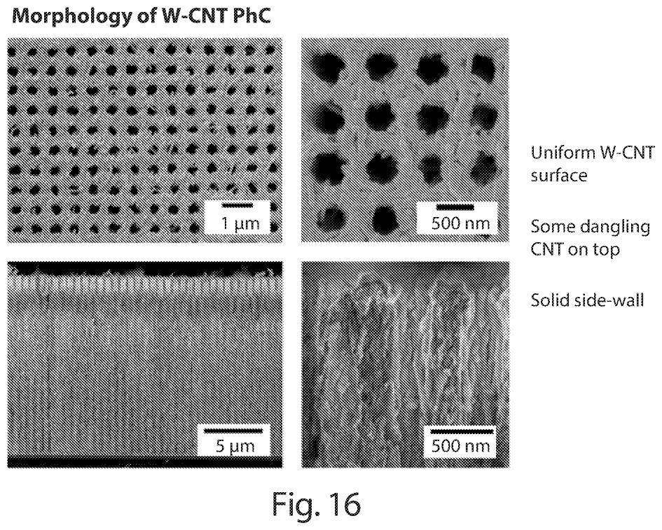

FIG. 16 shows micrographs of tungsten- and alumina-coated carbon nanotubes.

### 2. Results and Discussion

3.1 Morphology of W-CNT nanophotonic structure

The critical technical difficulty in the synthesis of nanopatterned CNT arrays may lie in the very low density of CNT arrays in conventional CVD system, in some cases. Here a new recipe was utilized which could fully activate the catalysts to achieve very high density in the nanoscale, in certain designs. For a nonpatterned substrate, the density of CNTs could reach 0.6 g/cm², an order of magnitude higher than those synthesized by conventional CVD systems. The top surface is very uniform throughout the whole nanophotonic surface.

SEM observations revealed that a typical 10-second-growth in the CVD system described in this Example yielded 20 μm-thick CNT arrays. Because of the high growth yield of the CVD process, the nanophotonic structure could achieve very high aspect ratios which may further extend the interaction time between the electromagnetic wave and the side wall of the nanocavities.

### 3.2 Optical Characterization and Thermal Stability

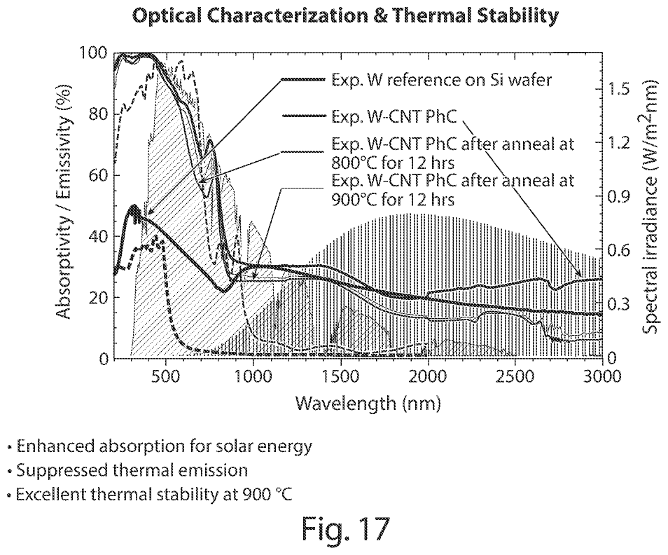

The reflectance spectrum of the W-CNT nanophotonic structure was characterized by UV-vis-NIR optical spectroscopy (Agilent Cary 5000) using an Al mirror as reference (Thorlab). Significant enhancement of photon absorbance in the visible range (200-900 nm) was observed compared with flat W sputtered on a polished Si/SiO₂ wafer (see FIG. 17). The suppression of optical absorbance in the near infrared range was not found right after ALD coating. This may be owing to the lack of crystallization of the W ALD. The nanopatterned W-CNT surface was then annealed at 800° C. for 12 hours to enable the crystallization of W. After annealing, the thermal emission in the NIR range was suppressed. The selectivity in the absorbance and emittance was successfully achieved using the nanopatterned W-CNT surface after appropriate annealing.

The thermal stability test was carried out at 900° C. under the He flow in the atmospheric pressure for 12 hours. The optical selectivity of the nanopatterned W-CNT surface was well maintained after annealing at 900° C. for 12 hrs. This may be because the CNT scaffold could support the whole nanostructure, and thus effectively prevent thermal degradation. Note that no protection layer was added during the whole thermal stability test. Interestingly, the optical absorption in the visible range was slightly improved, which suggests the nanopatterned W-CNT surface may bear even higher temperatures. Systematic thermal stability test at higher temperatures for longer time will be done for the next research step.

In this Example, a W-CNT-based photonic crystal structure was proposed and fabricated. This structure may be beneficial for high-temperature thermophotovoltaic (TPV) applications. A facile fabrication process for photonic crystals was realized through nanoscale patterning of catalysts, scalable CVD growth and W ALD coating. Selectivity in optical absorbance was observed, with enhancement in the visible range and suppression in the near infrared range. The W-CNT PhC structure, without coating any protection layer, demonstrated good thermal stability after annealing at 900° C. for 12 hrs. Further steps contemplated as future work include systematic optimization and analysis of W-CNT PhC, thermal stability tests at higher temperatures as well as simulation calibration.

### Example 2

In this Example, a tungsten-carbon nanotube (W-CNT) nanophotonic surface comprising W-CNT core/shell building blocks is described. Nanoscale holographic interferometry-based nanopatterning of catalysts, modulated chemical vapor deposition synthesis and conformal coating of CNTs are employed to form the nanophotonic surfaces. Certain W-CNT nanophotonic surfaces formed by this process may exhibit outstanding spectral and angular selectivity of photon absorbance and thermal emission, and/or excellent morphological and optical stability over 168 hrs annealing at 1273 K. In some cases, W-CNT nanophotonic structures formed by this process may show suppressed surface diffusion at the nanocavity edges. Using the W-CNT nanophotonic surfaces as the absorber and emitter, certain GaSb-based solar TPV (STPV) systems may have system efficiency surpassing Shockley-Queisser efficiency limit at modest operating temperatures and input powers.

In this Example, an approach for the fabrication of 2D PhCs for use in TPV systems which includes tungsten-carbon nanotube (W-CNT) core/shell building blocks is presented. This approach may realize manufacturing scalability, thermal stability and/or precise tunability of the optical properties. Some 2D PhCs—W-CNT nanophotonic surfaces described in this Example may function as broad-band solar absorbers and/or as narrow-band thermal emitters for a solar TPV (STPV) system. Some W-CNT nanophotonic absorbers and/or emitter demonstrate one or more beneficial properties, such as satisfactory spectral selectivity, satisfactory angular selectivity, and/or excellent thermal stability. The theoretical solar-to-electricity efficiency of the STPV system may have the potential to surpass the SQ efficiency limit.

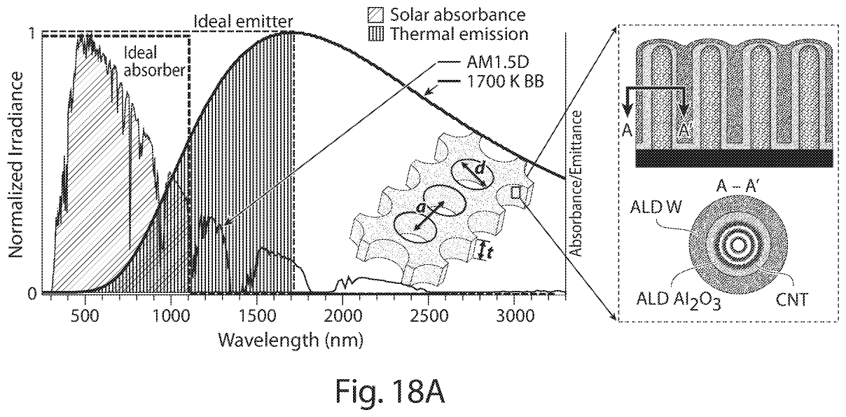

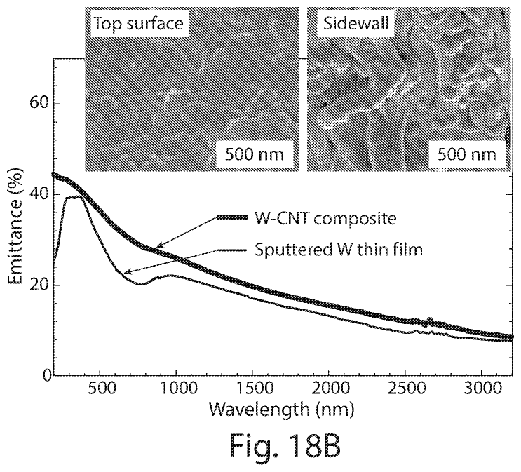

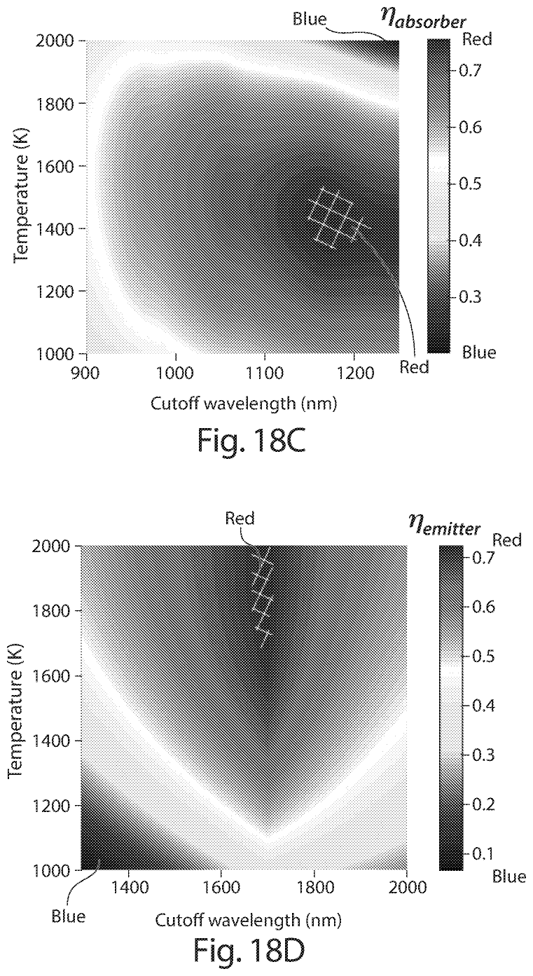

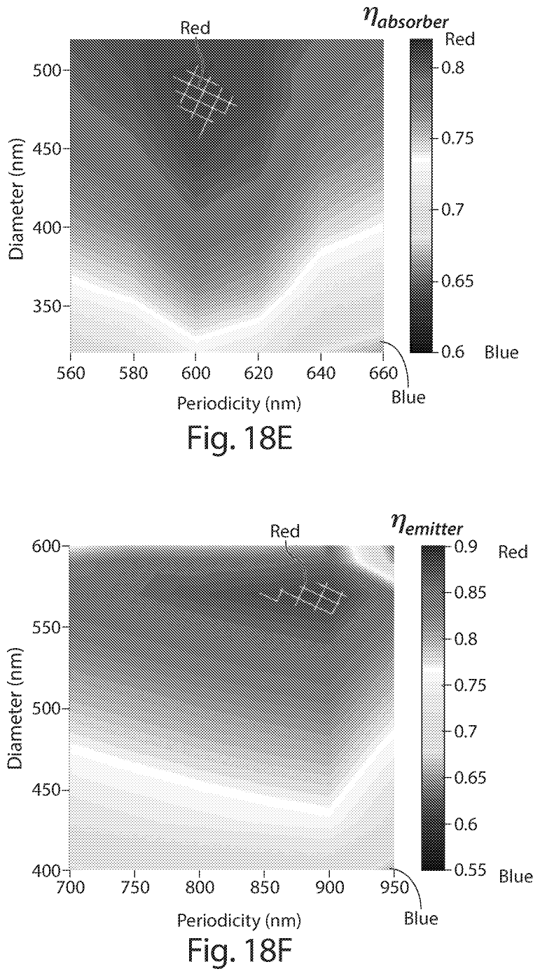

The W-CNT PhCs described in this Example may function as selective absorbers and/or selective emitters in STPV systems using an external GaSb photovoltaic (PV) cell. As shown in FIG. 18A, both the nanophotonic absorber and emitter have spectral cutoffs, together playing the role of a thermal rectifier. The absorber may convert full-spectrum solar irradiation to thermal energy (e.g., with unity absorbance), and/or may serve as a thermal insulation layer for the emitter (e.g., with zero emission). The thermal absorber may cause unidirectional thermal emission (or thermal emission that is close to unidirectional) to the PV cell. The emitter may then quench the radiation below the bandgap of the PV cell (e.g., with zero emittance) and/or enhance the thermal emission elsewhere (e.g., with unity emittance). Suppression of thermalization and/or sub-bandgap photons may significantly increase the maximum photon energy that is convertible to electricity. The spectral selectivity of the absorber and emitter can be tuned by designing the geometrical parameters (nanocavity diameter d, periodicity a and thickness t) of the W-CNT PhCs which are constructed by the W-CNT core/shell building blocks, as shown in the inset of FIG. 18A.

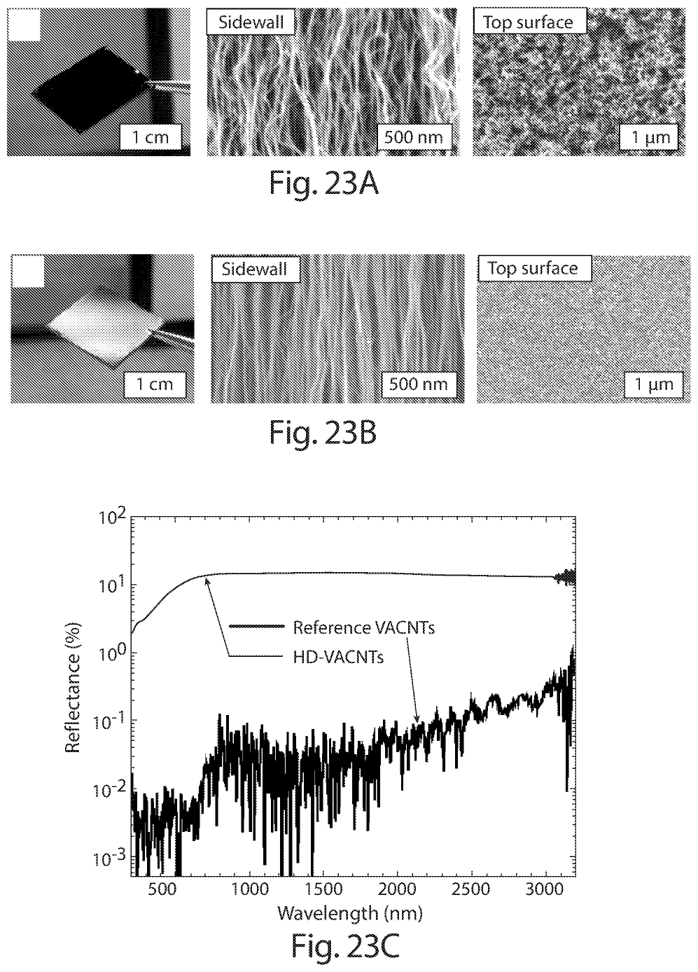

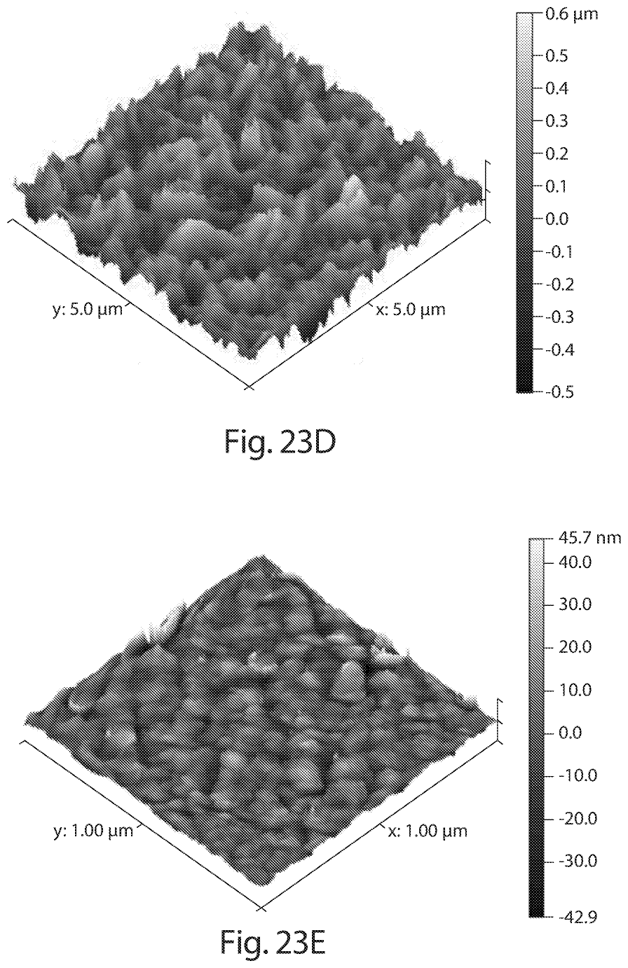

In this Example, patterned vertically aligned CNTs (VACNTs) are employed as a nanoporous scaffold for a nanophotonic structure. This nanophotonic structure may be thermally stable. The CNTs may be positioned within the nanophotonic structure in a uniform manner, and/or may be present in the nanophotonic structure at a high density. In some cases, submicron VACNT features may be present. A carbon pre-conditioning dynamic CVD process (see Experimental Section) was employed to fabricate the VACNTs. The surface of the reference low-density VACNTs may act as a blackbody absorbing light omnidirectionally, while the surface of the HD-VACNTs may be shiny and/or reflective. FIGS. 23A and 23B show micrographs of VACNTs and HD-VACNTs, respectively. AFM mapping results (FIG. 23D and FIG. 23E) show that the root mean square (RMS) values of the top surfaces of the reference VACNTs and the HD-VACNTs are 211.6 nm and 17.2 nm, respectively. The remarkably reduced roughness may be due to the increased CNT density and uniformity. The UV-vis-NIR reflection spectra (FIG. 23C) demonstrate that the reflectivity of the top surface of the HD-VACNTs (ca. 0.2) advantageously high.

After CNT growth, the W-CNT composite is formed by atomic layer deposition (ALD) of ca. 2-nm-thick Al₂O₃ and ca. 20-nm-thick W outside the CNT outer wall (See Experimental Section). The Al₂O₃ conformal coating may function as a seed layer for the subsequent W ALD process and a protection layer to avoid the formation of tungsten carbide. The SEM images in the insets of FIG. 18B demonstrate that the top surface of the HD-VACNTs with Al₂O₃ and W ALD (W-CNT composite) is smooth and solid, while the sidewall is composed of the W-CNT core/shell building blocks in contact with each other. UV-vis-NIR spectra of sputtered W thin film and the top surface of the unpatterned W-CNT composite are compared in FIG. 18B. The optical properties of the two spectra match well with each other in the visible and NIR ranges. The top surface of the unpatterned W-CNT composite has even higher absorptivity in the wavelength range less than 400 nm, which may be attributed to the roughness-induced Mie scattering.

The design of the W-CNT nanophotonic absorber and emitter for the STPV system can be divided into two steps: 1) optimization of the spectral cutoff position, and 2) optimization of the geometrical parameters (d, a and t) of the W-CNT PhCs to maximize the absorber/emitter figure of merit. The absorber figure of merit (η_{absorber}) is defined as the ratio of the stored thermal energy to the total solar irradiance multiplied by the Carnot efficiency,

$${η}_{absorber} = ( 1 - \frac{T}{{T}_{a}} ) [ C {\int }_{solar} d λα ( λ ) {I}_{s} ( λ ) - {\int }_{BB} d λα ( λ ) {I}_{BB} ( λ , T ) ] \text{/} [ C {\int }_{solar} d λ {I}_{s} ( λ ) ]$$

where C is the number of suns, λ is the wavelength, Iₛ the solar irradiance, I_{BB} is the blackbody radiation at T, Tₐ is the ambient temperature (300 K) and α is the spectral absorbance of the absorber. The emitter figure of merit (ηₑₘᵢₜₜₑᵣ) is the ratio of the energy contained in the electron-hole pairs in the PV cell to the total thermal energy irradiated from the emitter. The ηₑₘᵢₜₜₑᵣ as a function of energy E and temperature T is given as

$${η}_{emitter} = {\int }_{{E}_{g}}^{∞} \frac{{E}_{g}}{E} dE ɛ ( E ) {I}_{BB} ( E , T ) \text{/} {\int }_{0}^{∞} dE ɛ ( E ) {I}_{BB} ( E , T )$$

where ε is the spectral emittance of the emitter, and E_{g} is the bandgap of the GaSb cell, i.e., 0.7 eV. As indicator function-like spectral selectivity may not experimentally achievable, the spectral cutoff positions may be optimized using step function-like absorbance and emittance,

$${α}_{p} , {ɛ}_{p} ( λ ) = \{ \begin{matrix}0.95 ; λ \leq {λ}_{cutoff} \\ 0.05 ; λ > {λ}_{cutoff}\end{matrix} \qquad ( 3 )$$

here αₚ and εₚ respectively denote the absorbance and emittance, and λ_{cutoff} is the cutoff wavelength. The mapping result of η_{absorber} as a function of the spectral cutoff and STPV working temperature under 100 suns illumination is shown in FIG. 18C. The maximum absorber of 75.6% is observed in the spectral cutoff range of 1140-1220 nm when the operating temperature of the STPV system varies from 1270 K to 1560 K. At this value, the balance between the solar absorption and thermal emission at the operating temperature results in an optimum value of η_{absorber}. For the emitter, the optimal spectral cutoff is located at 1673 nm (FIG. 18D), which matches the electronic bandgap of the GaSb PV cells. With the increase of the STPV operating temperature, the ηₑₘᵢₜₜₑᵣ reaches the maximum value of 73.0% at 1900 K and slightly declines afterwards owing to the increased hot carriers.

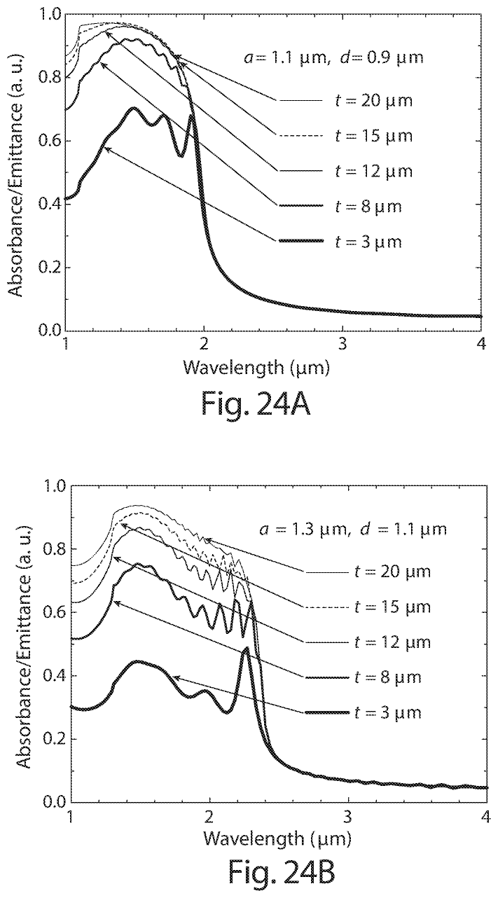

A finite-difference time domain method (FDTD, incorporated via MEEP) was employed. The material dispersion was extracted from the data in FIG. 18B using the Drude-Lorentz model to optimize the geometrical parameters of the W-CNT nanophotonic absorber and emitter (see Experimental Section). The absorbance and emittance values of each candidate were determined by measuring the reflectivity in FDTD using Kirchhoff's law of the thermal radiation. The effect of the thickness t on the spectral selectivity of two representative PhC designs (a=1.3/d=1.1 μm and a=1.1/d=0.9 μm) is shown in FIG. 24A and FIG. 24B. When the thickness increases from 2 μm to 12 μm, the absorbance/emittance in the wavelength range lower than the spectral cutoff is enhanced significantly. This may be because the increased thickness would allow longer interaction time for the photons and the sidewall of the nanocavity to reach the Q-matching status. However, further increasing the thickness to 15 and 20 μm does not result in remarkable changes in absorbance/emittance for both PhC designs, perhaps due to the saturation of photon absorbance. With the thickness t set as 15 μm, the diameter (d) and periodicity (a) of the nanocavity may be designed to realize matching status between the radiative and absorptive quality factors of the cavity resonances. The numerical optimization results of d and a for the W-CNT nanophotonic absorber and emitter are given in FIG. 18E and FIG. 18F, respectively. Both the maximum absorber and emitter are higher than 80% for the optimized combinations of d and a. The d/a is therefore designed to be 480/600 nm for the W-CNT nanophotonic absorber and 640/900 nm for the W-CNT nanophotonic emitter.

Nanoscale holographic interferometry method (see Experimental Section and FIG. 12) is used to form a mask with the periodic square array of nanocavities for patterning of catalysts for the first time. Combining the nanoscale holographic interferometry method with modulated CVD and ALD processes an additive nanomanufacturing method (FIG. 6A) is employed to realize the W-CNT PhCs with high aspect ratio over scalable areas and allow precise structural control at nanoscale. The nanopatterned catalyst layer composed of 1-nm-thick Fe and 10-nm-thick Al₂O₃ is achieved by the nanoscale holographic interferometry method (Process 1). To enable the nanoscale features of the VACNTs, the CVD process is modulated by carbon pre-conditioning (see Experimental Section) to synthesize the HD-VACNTs. The mixture of ethene and H₂O molecules can realize a CNT growth rate of 2 μm/s through the vapor-liquid-solid (VLS) scheme (Process 2). For the nanopatterned VACNTs (Process 3), the inter-CNT distance and CNT diameters of the VACNTs may be engineered to realize a smooth top surface with highly packed sidewalls, and/or to allow adsorption of trimethylaluminum (TMA) and ozone molecules for the conformal ALD of Al₂O₃(Process 4). The ozone molecules can facilitate the detachment of the Al₂O₃-CNT nanopatterned surface from the growth substrate (Process 5). 35 cycles of W ALD (see Experimental Section) are subsequently carried out on the Al₂O₃-CNT nanopatterned surface (Process 6). The W-CNT nanophotonic surface (Process 7) is formed after the inter-tube space of the Al₂O₃-CNT nanopatterned surface is filled with W.

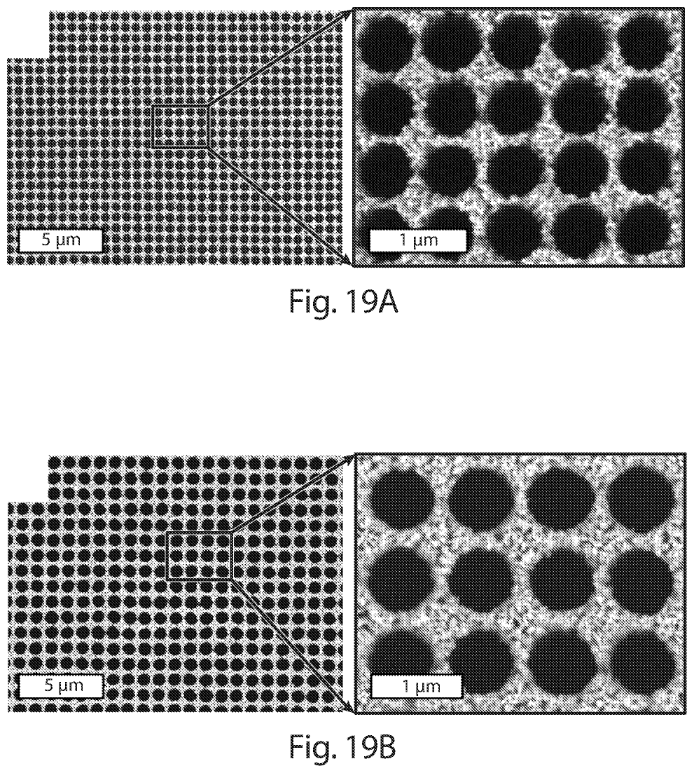

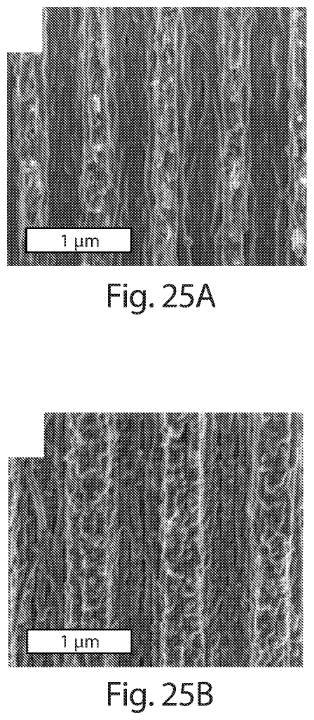

The W-CNT nanophotonic absorber and emitter with the numerically optimized parameters were fabricated using the process schemed in FIG. 6A. As shown in FIG. 19A and FIG. 19B, the nanopatterned VACNTs for the nanophotonic absorber and emitter demonstrate uniform top surfaces and clear-defined nanocavity edges. The extremely high kinetic energy of the carbon-containing molecules at the CVD temperatures guarantees the uniformity of the large-area nanopatterned VACNTs. The nanocavity diameter of the nanopatterned VACNTs was fabricated with allowances for the subsequent ALD processes. The standard deviations of the nanocavity diameter and periodicity of the nanopatterned VACNTs are both less than 30 nm. The VACNT wall thickness between adjacent nanocavities for the nanophotonic absorber is only 70 nm. The thickness of the nanopatterned VACNTs is ca. 15 μm. In this Example, the nanopatterned CNT arrays with the thickness of 15 or 20 μm can be easily realized within one minute by the CVD synthesis process. Moreover, the SEM images in FIG. 19C and FIG. 19D show that the clear-defined nanocavities are well maintained on the top surface of the W-CNT PhCs, and the nanocavity diameters of the nanophotonic absorber and emitter are accurately tuned to 480 nm and 640 nm, respectively. The sidewalls of the W-CNT PhCs are uniformly filled by the conformal W coating in the cylinders, as shown by the sideview SEM images of the W-CNT nanophotonic absorber and emitter in FIG. 25A and FIG. 25B. The nanofabrication process developed here may offer high manufacturing fidelity and/or nanocavity aspect ratio, possibly due to the precise nanopatterning of catalysts and the bottom-up nature of CNT synthesis process. The molecular additive manufacturing method described in this Example is scalable in certain cases: the nanoscale holographic interferometry can be performed with simple optical setup in the ambient; both CNT growth and ALD may be formed from vapor-phase processes which can be deployed in a roll-to-roll fashion; and the method can be performed without conventional masks or scanning lithography methods in some cases.

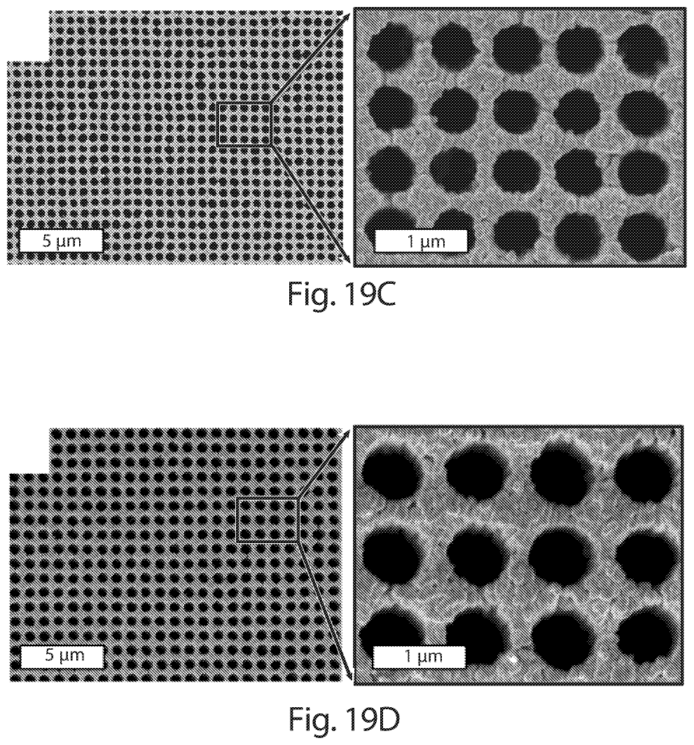

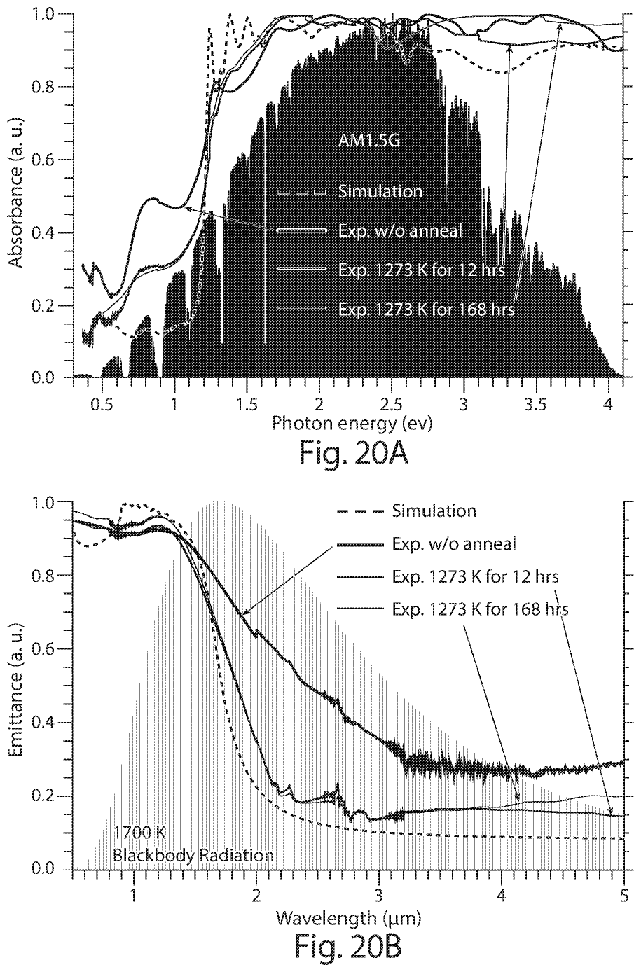

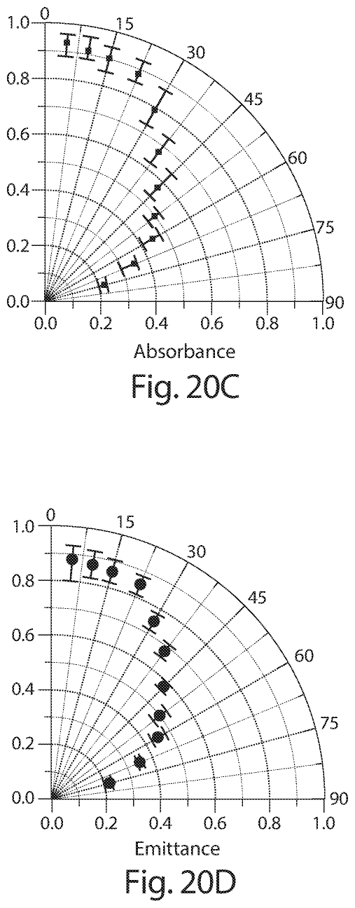

As shown by the UV-vis-NIR spectra in FIG. 20A, the spectral cutoff of the W-CNT nanophotonic absorber which is located at 1.1 eV (1130 nm) may be very steep, and near-unity absorbance may be observed in the photon energy band higher than 1.2 eV. The W-CNT nanophotonic emitter may also possesses a steep spectra cutoff wavelength at 1600 nm and/or near-unity emittance at wavelengths below 1300 nm (FIG. 20B). The cutoffs of the measured spectra generally match the corresponding FDTD numerical simulations, but the experimental values of the absorbance and emittance are slightly higher than the simulation results over the whole spectra. This phenomenon may be attributed to diffuse reflection from the surface roughness of the W-CNT PhCs. The greater absorbance and emittance at wavelengths above the cutoffs could cause parasitic re-emission to the environment and the sub-bandgap photon emission, which could decrease the STPV system efficiency. This could be circumvented by polishing, which could reduce the surface roughness significantly.

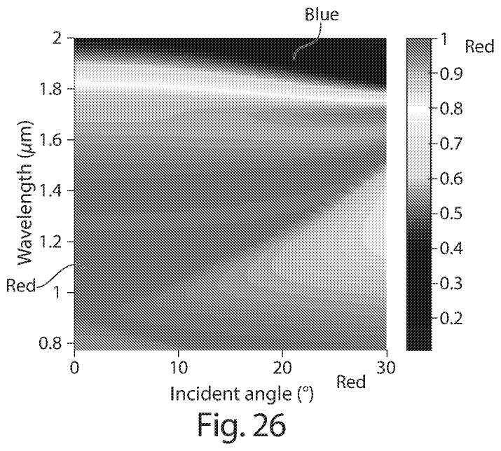

The efficiency of STPV system may also affected by the incident angle of the thermal emission. When the thermal emission impinges on the PV cell at oblique angles, the surface recombination rate of the electron-hole pairs may increase, which may result in considerable losses in the system efficiency and/or ultimate power output. In this Example, the angular-dependent absorbance and emittance of the W-CNT nanophotonic absorber and emitter are measured by UV-vis-NIR spectroscopy using variable angle spectral reflectance accessory (VASRA), as respectively shown in FIG. 20C and FIG. 20D. The angle denotes the oblique incidence of the thermal emission diverging from the normal direction. The measured absorbance and emittance are averaged in the wavelength range of 300-800 nm. Both the average absorbance and emittance are greater than 0.8 in the angle range of 0-22.5° and decline when the incident angle further increases, which is consistent with the FDTD simulations of the angular dependence of the W-CNT nanophotonic absorber and emitter (FIG. 26). Therefore, the high absorbance of the W-CNT nanophotonic absorber can provide a 45° acceptance cone for the concentrator design and limit the radiation loss to the environment outside the acceptance cone. Furthermore, the limited emission angle of the W-CNT nanophotonic emitter can effectively mitigate the non-radiative recombination (Shockley-Read-Hall recombination) in the PV cell, which can benefit the power conversion efficiency and output density of the STPV system.

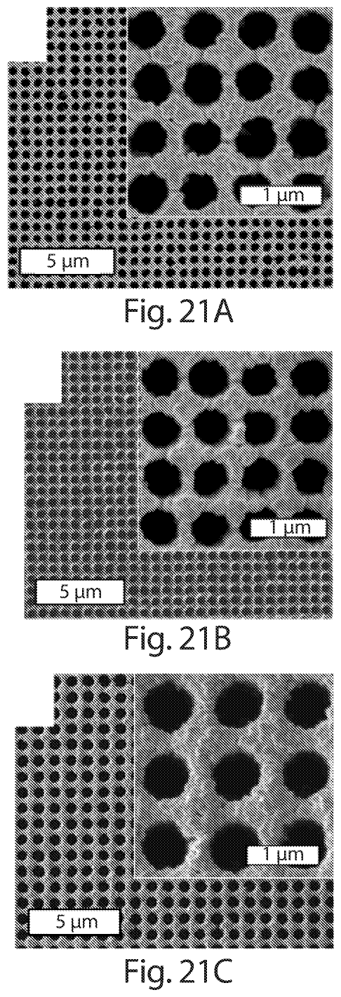

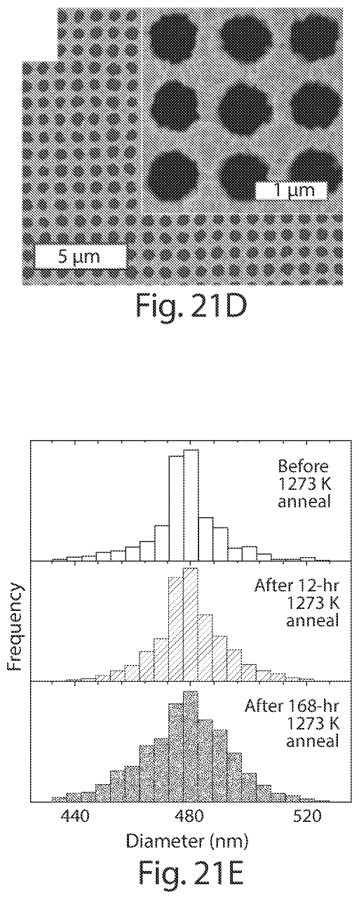

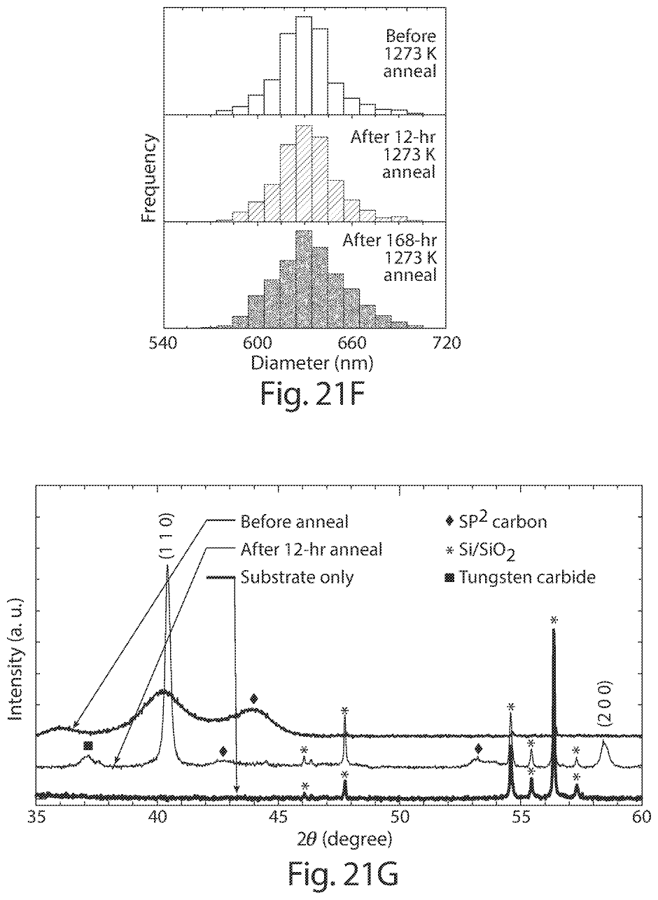

FIG. 20A and FIG. 20B also illustrate that, after 12-hr and 168-hr 1273 K annealing in 10⁻³ Torr vacuum with He protection, the spectral selectivity does not deteriorate for either the W-CNT nanophotonic absorber or the W-CNT nanophotonic emitter. The values of η_{absorber} and ηₑₘᵢₜₜₑᵣ before annealing, and after 12-hr and after 168-hr 1273 K annealing processes are given in Table 1. The η_{absorber} achieves 84% for only 100 suns illumination with ignorable changes after 168-hr 1273 K annealing. The ηₑₘᵢₜₜₑᵣ is relatively low (38%) before 1273 K annealing, but increases to be higher than 50% after 168-hr 1273 K annealing. The SEM images in FIGS. 21A-21D show that, after 12-hr and 168-hr 1273 K annealing, the sharp nanocavity edges of the nanophotonic absorber and emitter are maintained intact, with only the development of minor roundness and no structural collapse. Although the nanocavity size distribution becomes broader (FIG. 21E and FIG. 21F), the mean diameters of the nanocavities of both the W-CNT nanophotonic absorber and emitter remain unchanged (Table 1). The thin-film XRD spectra of the W-CNT nanophotonic surface before and after 12-hr 1273 K annealing process are compared in FIG. 21G, using the Si/SiO₂ substrate as reference. The predominant peaks of (1 1 0) plane at 40.3° and (2 0 0) plane at 58.3° are observed after 12-hr annealing at 1273 K, demonstrating the phase transition from nanocrystallinity for the as-deposited ALD W to alpha-phase (bcc) crystallinity for the ALD W after annealing. The W ALD grains in the annealed samples (FIG. 21C and FIG. 21D) are slightly coarser with fewer boundaries and defects than those in the non-annealed samples (FIG. 19C and FIG. 19D). At higher temperatures, the defect sites can reorder and/or gradually release points of disorders and/or residual stress accumulated during deposition. Additionally, it appears that the ALD W coating layers on the top surfaces of the W-CNT PhCs become denser and smoother after annealing. The increased crystallinities and W ALD grains as well as the smoother top surfaces of the W-CNT PhCs after annealing may result in higher optical reflectivity (metallicity) in the near infrared range, and/or suppressing the thermal emission above cutoffs, which may improve the optical performance. For the practical applications in STPV systems, the W-CNT nanophotonic surfaces could be facilely annealed by the high operating temperatures to boost the optical selectivity.

TABLE 1
Average diameter, standard deviation of the nanocavities and optical
properties of the W-CNT nanophotonic absorber and emitter before
annealing, after 12-hr and after 168-hr annealing at 1273 K.

| | | Nanocavity | | | |
|---|---|---|---|---|---|
| Annealing | | Diameter | | Optical | |
| Time | | Avg. | Std. | Properties | |
| (hours) | | (nm) | Dev. | η_{absorber} (%) | ηₑₘᵢₜₜₑᵣ (%) |
| Absorber | 0 | 479.3 | 16.66 | 84.2 | n/a |
| | 12 | 480.9 | 18.54 | 81.3 | n/a |
| | 168 | 483.0 | 20.27 | 81.7 | n/a |
| Emitter | 0 | 633.3 | 19.41 | n/a | 38.7 |
| | 12 | 635.9 | 21.17 | n/a | 50.2 |
| | 168 | 638.5 | 22.79 | n/a | 50.8 |

Two factors may explain the high thermal stability of the W-CNT PhCs described in this Example. Firstly, the nanocavities in the W-CNT PhCs are realized by the bottom-up assembly of the W-CNT core/shell building blocks rather than abrupt geometrical changes of the bulk metals. The additive nanomanufacturing process could avoid residual etching contaminants and process-induced surface defects which may degrade the surface integrity of W. The surface diffusion rate over the whole W-CNT PhCs may be uniform and/or may lack locally accelerated surface diffusion rate near the nanocavity edges. Moreover, the HD-VACNTs with ultrahigh thermal stability may serve as good scaffolds which maintain nanostructure integrity and/or avoid structural collapse at high operating temperatures.

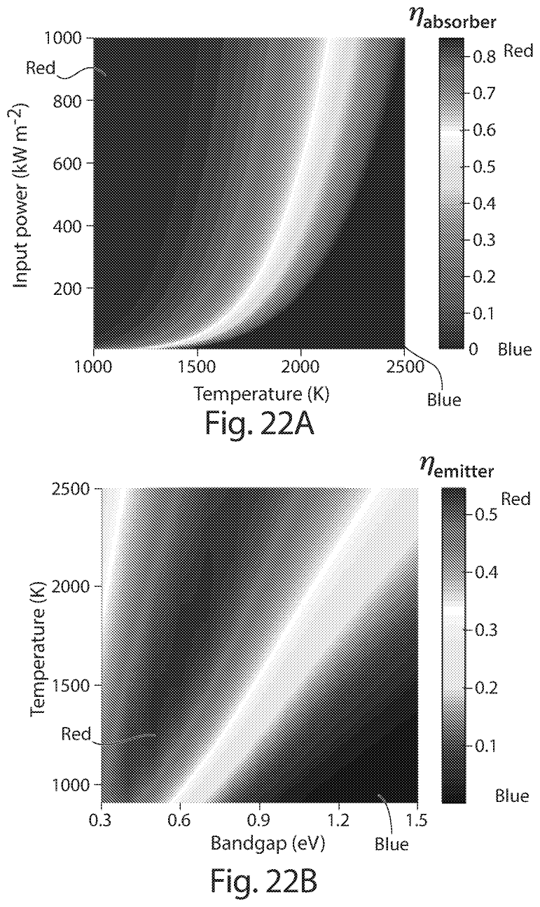

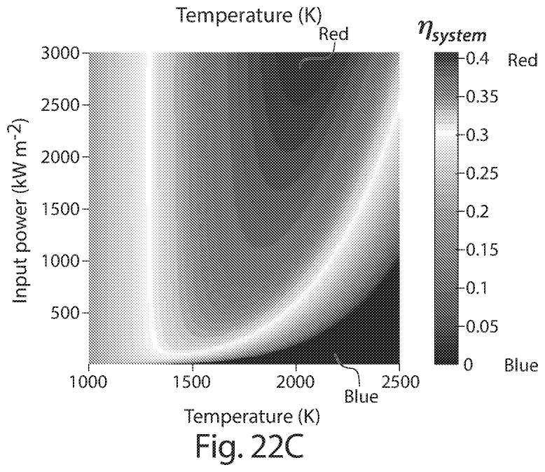

A 1D thermal diode model is used to estimate the power conversion efficiency of a planar STPV system with the W-CNT nanophotonic absorber and emitter. The model utilizes the experimentally measured spectral properties of the W-CNT PhCs to analyze the STPV system efficiency at input powers (100-3000 kW m⁻²) and operating temperatures (1000-2500 K) beyond laboratory capabilities. The model neglects power losses in STPV modules including thermal loss from system support and packaging as well as resistive loss from PV cells. First, η_{absorber} as a function of solar input power and operating temperature is mapped in FIG. 22A. With modest input powers (<1000 kW m⁻²), the η_{absorber} of an the W-CNT nanophotonic absorber is over 90% at relatively low operating temperatures (1000-1400 K). This demonstrates that the W-CNT nanophotonic absorber functions as a good thermal diode between the sun and the emitter at the thermally stable temperature (1273 K). Obtaining comparable η_{absorber} values at higher operating temperatures (>1400 K) may require higher input powers (>1000 kW m⁻²), which may not be cost-effective in practical STPV applications. FIG. 22B shows the ηₑₘᵢₜₜₑᵣ mapping result of the W-CNT nanophotonic emitter matching PV cells with different bandgaps at various operating temperatures. The maximum ηₑₘᵢₜₜₑᵣ (54%) is achieved at operating temperatures ranging from 1200 to 2200 K, corresponding to PV bandgap ranging from 0.5 to 0.7 eV. Each PV bandgap has an optimal operating temperature. Further increase of the operating temperature could lead to a decreased ηₑₘᵢₜₜₑᵣ because of the increased above-bandgap emission. At the thermally stable temperature (1273 K), the ηₑₘᵢₜₜₑᵣ of an the W-CNT nanophotonic emitter is over 42%, and matches a wide PV bandgap range from 0.3 to 0.7 eV, which may indicate that the W-CNT nanophotonic emitter works as an effective thermal diode between the absorber and the PV cell.

The STPV system efficiency (η_{system}) is a product of η_{absorber} and ηₑₘᵢₜₜₑᵣ as well as the correction factors of PV cells. The GaSb PV cell with bandgap of 0.7 eV is used as a demonstration. Both the absorber/emitter area ratio and the emitter/PV view factor are assumed unity. The η_{system} is as estimated a function of input power (100-3000 kW m⁻²) and operating temperature (1000-2500 K), as demonstrated in FIG. 22C. At the thermally stable operating temperature (1273 K), the η_{system} of the STPV system exceeds the SQ efficiency limit of the GaSb PV cell (23%) under input power of 200 kW m⁻², and reaches as high as 33% under input power of 1000 kW m⁻². Increasing the input power to 3000 kW m⁻² and operating temperature to 2000 K results in a minor increase of the η_{system} to 41%. Therefore, the pursuit of ultra-high thermally stable temperatures of the W-CNT PhCs is not necessary. The potential to surpass the SQ efficiency limit over wide range of input powers of the W-CNT PhCs as nanophotonic absorber and emitter for STPV systems may be advantageous.

In summary, this Example describes a W-CNT building block material for 2D PhCs, and demonstrates scalable manufacturing method with nanometer scale tunability to fabricate 2D PhCs. Some W-CNT PhCs exhibit excellent spectral and angular selectivity as well as outstanding thermal stability after 168-hr 1273 K annealing. Using the measured optical properties of the W-CNT nanophotonic absorber and emitter, the GaSb-based STPV system can surpass the SQ efficiency limit computationally. The highly precise nanopatterned CNT template can be infiltrated by a wide range of matrix to create high-aspect ratio periodic nanostructures which cannot be easily patterned using top-down chemical etching methods. The CNT-based nanophotonic surfaces may also show promise for application to other high-temperature energy conversion devices, such as photo-thermionic energy converter, solar thermoelectric converter and/or thermophotonic solar cells.

### Experimental Section

Catalyst nanopatterning using nanoscale holographic interferometry. A bilayer stack of a bottom anti-reflection coating (BARC, Brewer Science XHRi-16) and a negative photoresist layer (Futurrex NR7-250) were spin-coated on the catalyst substrate composed of Fe (1 nm) on Al₂O₃ (10 nm), followed by baking at 180° C. The bilayer stack was exposed by the HeCd laser (λ=325 nm) using a Lloyd's mirror setup. The periodicity of the nanopattern is given by (λ/2)/sin(θ/2), where θ is the angle of the Lloyd's mirror. The achievable periodicity range may span ca. 175 nm to ca. 1500 nm. The periodic square array of nanocavities was developed by tetramethylammonium hydroxide (Futurrex RD-6). The exposed BARC and catalyst layer were then removed by minute-long NaOH wet etching or He—O₂ RF plasma dry etching process (Plasma-Therm). Then the residues and contaminants were removed by a scotch tape.

Synthesis of high-density vertically aligned CNTs (HD-VACNTs). The HD-VACNTs were synthesized using a carbon pre-conditioning dynamic CVD process. The CVD system was fully automated, i.e., Robofurnace. A thin layer of carbon was first deposited on the inner wall of the CVD chamber at 750° C. by the flow mixture of C₂H₄ and wet helium for 5 min. With the system temperature maintained at 750° C., a transfer arm carrying a Si/SiO₂ substrate loaded with the catalysts was inserted into the hot chamber. After annealing at 750° C. for 10 min, the substrate was retracted from the hot chamber to cool down. The precursors—C₂H₄ and wet helium—were then introduced into the hot chamber. The substrate was inserted again after the stabilization of the precursor flow (ca. 5 min). The typical growth rate of the CNT array was 2 μm/sec.

Atomic layer deposition (ALD) of Won CNT arrays. Before the W ALD process, a 2-nm-thick and conformal Al₂O₃ layer was deposited on the CNT arrays by 30 cycles of ALD using ozone and trimethylaluminum (TMA) as precursors. The Al₂O₃ deposition rate was approximately 0.06 nm per cycle. Metallic tungsten ALD (W ALD) was performed in a home-built flow tube reactor at 220° C., with an inert Ar carrier flow rate of 210 sccm to produce a baseline pressure of 1.5 Torr. The W ALD process consisted of alternately exposing the Al₂O₃-coated CNT arrays to the diluted SiH₄ (2% in Ar) and WF₆, followed by Ar gas purges after each reagent pulse to prevent CVD-like growth. Typical precursor exposures (1 L=10⁻⁶ Toms) were approximately 6×10⁵ L, 5×10⁵ L and 1×10⁷ L for SiH₄, WF₆ and Ar, respectively. The W deposition rate was approximately 0.5-1 nm per cycle. The W-CNT core-shell building block was formed by 35 cycles of W ALD. The as-deposited W-CNT nanocomposites were then annealed at 1073 K for one hour to help densify and stabilize the W film which is deposited at low temperature (220° C.).

FDTD numerical simulation. The nanophotonic surface was designed based on finite-difference time domain (FDTD) method, using MIT Electromagnetic Equation Propagation (MEEP) package. The material dispersion of the W-CNT core/shell structure was obtained by curve fitting of the reflectance of the W-CNT structure (top surface) to the Lorentz-Drude model. The design of the W-CNT nanophotonic surface was optimized by tuning the periodicity a, nanocavity diameter d and thickness t.

Characterization. Microscale morphologies of the nonpatterned VACNTs, nonpatterned HD-VACNTs, nanopatterned VACNTs as well as the W-CNT nanophotonic surfaces before and after 1273 K annealing were characterized by SEM (Zeiss Merlin with Gemini II column). The top surface roughness of the nonpatterned VACNTs and HD-VACNTs was characterized by AFM (Veeco Metrology Nanoscope IV). The optical properties were measured by UV-vis-NIR transmission/reflectance spectrophotometer (Varian/Cary-5000) and Fourier transform infrared spectrometer (Thermo Fisher FTIR6700) using a commercial reference aluminum coated mirror (Thorlabs). The angular dependence of optical properties was measured using variable angle spectral reflectance accessory (VASRA). The thin-film XRD spectra of the ALD W of the W-CNT PhCs before and after 1273 K annealing were measured by x-ray diffractometer (Rigaku Smartlab).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A material comprising a network of carbon nanotubes (CNTs), where material is structured with a periodic pattern having a characteristic dimension smaller than 1 um, and where the CNTs are coated with a second material.

2. The material of claim 1 where the CNTs are oriented primarily perpendicular to the substrate surface.

3. The material of claim 1 where the second material is chosen from among W, Mo, TiN, Al₂O₃, or other refractory metals or ceramics.

4. The material of claim 1 where the CNTs are coated with multiple materials.

5. The material of claim 1 configured as an emitter in a thermophotovoltaic device.

6. (canceled)

7. A thermophotovoltaic device comprising a surface including CNTs patterned with a periodic arrangement with a characteristic dimension of 1 um or smaller.

8. An optical material, comprising:
a matrix comprising a collection of elongated nano structures and a coating material at least partially coating the collection of elongated nanostructures, and
an array comprising a plurality of cavities disposed within the matrix.

9. An optical material as in claim 8, wherein the optical material is disposed over at least a portion of an emission surface.

10. An optical material as in claim 8, wherein the optical material is part of or disposed on an emitter.

11. An optical material as in claim 8, wherein, after the emitter has been heated to a temperature of at least 1200 Kelvin for a period of at least 150 hours, the emitter is capable of exhibiting an emission efficiency of at least 40%.

12. An optical material as in claim 8, wherein the optical material is disposed over at least a portion of an absorption surface.

13. An optical material as in claim 8, wherein the optical material is part of or disposed on an absorber.

14. An optical material as in claim 13, wherein, after the absorber has been heated to a temperature of at least 1200 Kelvin for a period of at least 150 hours, the absorber is capable of exhibiting an absorption efficiency of at least 85%.

15-26. (canceled)

27. The optical material of claim 8, wherein the optical material is a photonic crystal.

28. The optical material of claim 8, wherein the matrix is configured to be stable at a temperature of greater than or equal to 1000° C. for a period of greater than or equal to 168 hours.

29. The optical material of claim 8, wherein the matrix has an average thickness of greater than or equal to 1 micron and less than or equal to 1000 microns.

30. The optical material of claim 8, wherein at least a portion of the cavities are filled with a gas.

31. The optical material of claim 30, wherein the gas is air.

32. The optical material of claim 8, wherein at least a portion of the cavities are filled with a liquid.

33. The optical material of claim 8, wherein at least a portion of the cavities are filled with a solid.

34-75. (canceled)
